(19) United States
(12) Patent Application Publication
(10) Pub. No.: US 2011/0043525 A1
(43) Pub. Date: Feb. 24, 2011

(54) DRAWING CORRECTION ASSISTING APPARATUS, DRAWING CORRECTION ASSISTING METHOD, AND STORAGE MEDIUM

(75) Inventors: Youji UCHIKURA, Kawasaki (JP); Akio Sakamoto, Kawasaki (JP); Kenji Ishizuka, Kawasaki (JP); Yoshihito Okuwaki, Kawasaki (JP); Kazuhiko Hamazoe, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/858,179

(22) Filed: Aug. 17, 2010

(30) Foreign Application Priority Data
Aug. 20, 2009 (JP) 2009-190744

(51) Int. Cl. G06T 15/20

(52) U.S. Cl. 345/427

(57) ABSTRACT

A drawing correction assisting method executed by a computer, the method includes: dividing a drawing area of two-dimensional drawing data into unit areas and storing positional information for every unit area in a storage unit; allocating at least one of the unit areas to each of the plurality of drawing elements included in the drawing area on the basis of arrangement information about each the drawing element and the positional information for every unit area and storing association information associating each drawing element with the allocated at least one unit area in the storage unit; and determining whether interference occurs between the plurality of drawing elements on the basis of the presence of duplication of the allocated unit areas in the stored association information.

### CROSS-REFERENCE TO RELATED APPLICATION

This application is based upon and claims the benefit of priority from the prior Japanese Patent Application No. 2009-190744 filed on Aug. 20, 2009, the entire contents of which are incorporated herein by reference.

### BACKGROUND

1. Field

The embodiments discussed herein relate to assistance of drawing correction. For example, various embodiments relate to assistance of correction of interference between elements in drawing data.

2. Description of Related Art

Some three-dimensional computer aided design (CAD) systems in related art have a function of converting three-dimensional CAD data into two-dimensional CAD data. With this function, dimension elements (e.g., dimension values, dimension lines, and extension lines) are automatically arranged in the two-dimensional CAD data.

However, the appearance of the dimension elements that are automatically arranged is not necessarily suitable for use without change and it is sometimes necessary to correct the appearance of the dimension elements to some extent. Specifically, there are cases in which dimension elements are overlapped with (interfere with) other dimension elements or drawing elements. In addition, there are cases in which interference occurs in other drawing elements as the result of the conversion into two-dimensional CAD data.

Manual correction of such interference by persons can cause failure in the correction and typically achieves a low working efficiency.

Refer to Japanese Patent No. 2966441 and Japanese Laid-Open Patent Publication No. 05-61927.

### SUMMARY

According to an embodiment, a drawing correction assisting method executed by a computer, the method includes: dividing a drawing area of two-dimensional drawing data into unit areas and storing positional information for every unit area in a storage unit; allocating at least one of the unit areas to each of the plurality of drawing elements included in the drawing area on the basis of arrangement information about each the drawing element and the positional information for every unit area and storing association information associating each drawing element with the allocated at least one unit area in the storage unit; and determining whether interference occurs between the plurality of drawing elements on the basis of the presence of duplication of the allocated unit areas in the stored association information.

It is to be understood that both the foregoing summary description and the following detailed description are exemplary and explanatory as to some embodiments of the present invention, and not restrictive of the present invention as claimed.

### BRIEF DESCRIPTION OF DRAWINGS

FIG. 1 is a block diagram illustrating an example of the hardware configuration of a drawing correction assisting apparatus according to an embodiment of the present invention;

FIG. 2 is a block diagram illustrating an example of the functional configuration of a drawing correction assisting apparatus according to an embodiment of the present invention;

FIG. 3 illustrates an example of a process performed by the drawing correction assisting apparatus;

FIG. 4 illustrates an example of the data structure of drawing data according to an embodiment of the present invention;

FIG. 5 illustrates an example of how drawing data is displayed;

FIG. 6 illustrates examples of attribute information about each drawing element;

FIG. 7 illustrates an example of a set of dimension elements;

FIG. 8 illustrates an example of a group of dimension elements;

FIG. 9 illustrates an example of a drawing area divided into unit areas;

FIG. 10 illustrates an example of a process of allocating the unit areas to a drawing frame area and a title;

FIG. 11 illustrates an example of a process of allocating the unit areas to a view;

FIG. 12 illustrates an example of a process of allocating the unit areas to a dimension element and a note;

FIG. 13 illustrates an example of how the addresses of unit areas are allocated to a dimension value;

FIG. 14 illustrates an example of how the addresses of unit areas are allocated to a dimension line;

FIG. 15 illustrates an example of how the addresses of unit areas are allocated to an extension line;

FIG. 16 illustrates an example of a process of determining interference between drawing elements and correcting the arrangement position;

FIG. 17 illustrates an example of how to determine whether the interference occurs between drawing elements on the basis of the addresses of unit areas;

FIG. 18 illustrates examples of the correction processes that are performed in combinations of the drawing elements that interfere with each other;

FIG. 19 illustrates Correction process 1 in detail;

FIG. 20 illustrates an example including a view that is copied into a next page and dimension elements that are moved to the next page;

FIG. 21 illustrates Correction process 3 in detail;

FIG. 22 illustrates examples of relative arrangement positions with respect to a target graphic;

FIG. 23 illustrates an example of the relationship between a reference point of a dimension value and an extension point of an extension line;

FIG. 24 is a table illustrating the content of determination of the relative arrangement position of a target dimension element with respect to a target graphic, based on comparison between a reference point of a dimension value and an extension point;

FIG. 25 illustrates an example of how to correct the interference between dimension values;

FIG. 26 illustrates an example of how to correct the interference between a dimension value and a dimension line;

FIG. 27 illustrates an example of how to correct the interference between dimension lines;

FIG. 28 illustrates Correction process 4 in detail;

FIG. 29 illustrates an example of how to correct the interference between a dimension value and an extension line;

FIG. 30 illustrates Correction process 5 in detail;

FIG. 31 illustrates an example of how to correct the interference between extension lines;

FIG. 32 illustrates examples of the interference concerning or involving notes;

FIG. 33 illustrates Correction process 6 in detail; and

FIG. 34 illustrates Correction process 7 in detail.

### DESCRIPTION OF EXAMPLE EMBODIMENTS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element layer between the two elements, or one or more intervening elements may also be present. Like reference numerals refer to like elements throughout.

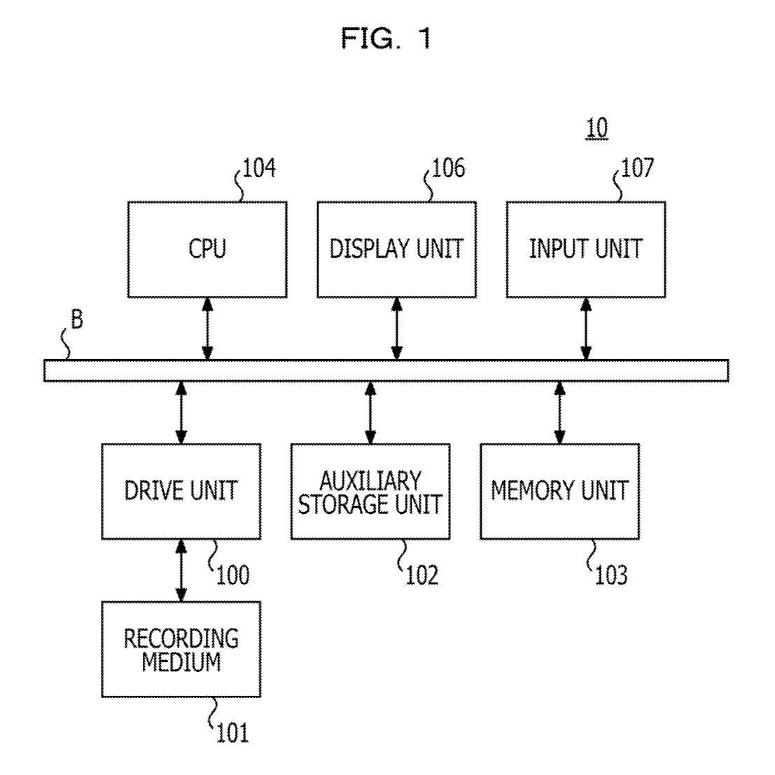

Embodiments of the present invention will herein be described with reference to the attached drawings. FIG. 1 is a block diagram illustrating an example of the hardware configuration of a drawing correction assisting apparatus according to an embodiment of the present invention. Referring to FIG. 1, a drawing correction assisting apparatus 10 includes a drive unit 100, an auxiliary storage unit 102, a memory unit 103, a central processing unit (CPU) 104, a display unit 106, and an input unit 107 that are connected to each other via a bus B.

Programs realizing processes in the drawing correction assisting apparatus 10 are supplied from a recording medium 101, such as a compact disc-read only memory (CD-ROM). Upon loading of the recording medium 101 having the programs recorded thereon in the drive unit 100, the programs are installed from the recording medium 101 into the auxiliary storage unit 102, such as a hard disk drive, through the drive unit 100, such as an optical disk drive. However, the programs need not be installed from the recording medium 101 and may be downloaded from another computer over a network. The auxiliary storage unit 102 stores the programs that are installed and also stores, for example, required files and data.

The memory unit 103 reads out programs from the auxiliary storage unit 102 in response to instructions to invoke the programs and stores the readout programs. The CPU 104 realizes functions concerning the drawing correction assisting apparatus 10 in accordance with the programs stored in the memory unit 103. The display unit 106 displays, for example, graphical user interfaces (GUIs) based on the programs. The input unit 107 includes, for example, a keyboard and a mouse and is used to input various operational instructions.

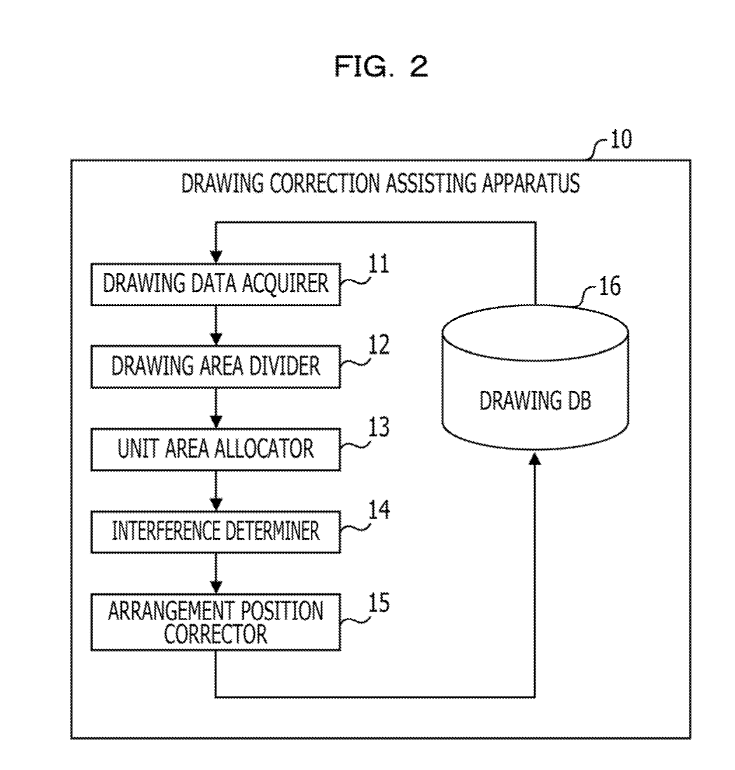

FIG. 2 is a block diagram illustrating an example of the functional configuration of a drawing correction assisting apparatus according to an embodiment of the present invention. Referring to FIG. 2, the drawing correction assisting apparatus 10 includes a drawing data acquirer 11, a drawing area divider 12, a unit area allocator 13, an interference determiner 14, an arrangement position corrector 15, and a drawing database (DB) 16. These components are realized by the processes that are executed by the CPU 104 in response to the programs installed in the drawing correction assisting apparatus 10.

The drawing data acquirer 11 acquires (reads out) drawing data (two-dimensional CAD data) to be processed (to be corrected) from the drawing DB 16 and decomposes the readout drawing data in the memory unit 103 as a processing target. The drawing DB 16 is a database that manages the drawing data by using, for example, the auxiliary storage unit 102. According to the present embodiment, the drawing data registered in the drawing DB 16 results from automatic conversion of three-dimensional CAD data by a three-dimensional CAD system. However, the drawing data to which the present embodiment is applicable is not limited to the one resulting from the automatic conversion of three-dimensional CAD data. The drawing data may be interactively generated in a common two-dimensional CAD system. Even when the drawing data is interactively generated, drawing may be performed to cause interference between drawing elements depending on the ability of an operator.

The drawing elements include all the elements arranged in a drawing. Accordingly, the drawing elements include not only graphics representing the shape of an object represented by the drawing but also a drawing frame area, a title, notes, dimension elements (dimension values, dimension lines, and extension lines), and so on.

The drawing area divider 12 divides a drawing area indicated by the drawing data to be processed into a mesh pattern or a grid pattern. Multiple unit areas are virtually formed in the drawing area as the result of the division.

The unit area allocator 13 allocates, to each drawing element included in the drawing data (drawing) to be processed, the unit areas with which at least part of the area of the drawing element is overlapped (associates the unit areas with the drawing element).

The interference determiner 14 determines whether the interference (overlapping) occurs between the drawing elements on the basis of the presence of the duplication of the unit areas. If the same drawing element is allocated to two drawing elements, the interference determiner 14 determines that the interference occurs between the two drawing elements.

The arrangement position corrector 15 corrects the position in the drawing where the drawing elements determined to have the interference are arranged. The arrangement position corrector 15 corrects the arrangement position by a process corresponding to the types of the drawing elements determined to have the interference.

The drawing DB 16 needs not be included in the drawing correction assisting apparatus 10. For example, the drawing DB 16 may be included in a computer or a storage unit connected to the drawing correction assisting apparatus 10 over a network.

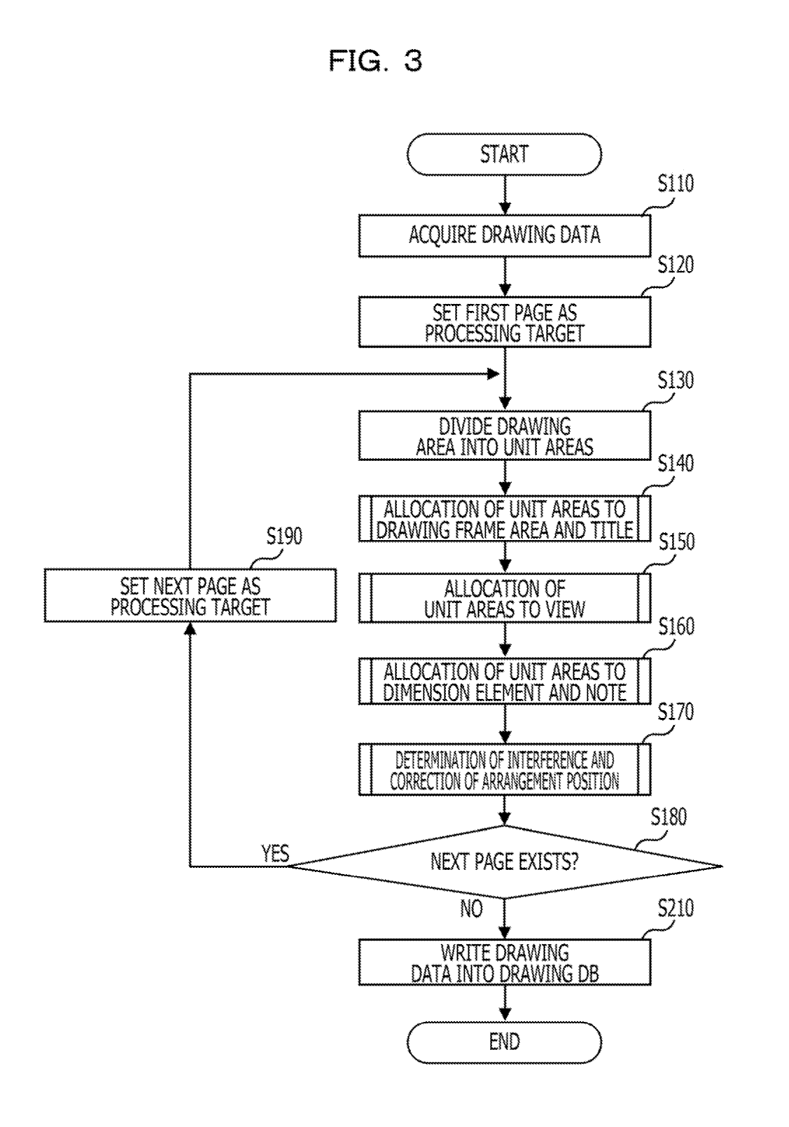

Processes performed by the drawing correction assisting apparatus 10 in FIG. 1 will now be described. FIG. 3 illustrates an example of a process performed by the drawing correction assisting apparatus 10.

Referring to FIG. 3, for example, upon selection of drawing data to be processed (to be corrected) from a list of the drawing data registered in the drawing DB 16 by a user, in Step S110, the drawing data acquirer 11 acquires the selected drawing data from the drawing DB 16 and decomposes the acquired drawing data in the memory unit 103. The drawing data decomposed in the memory unit 103 is used as the processing target.

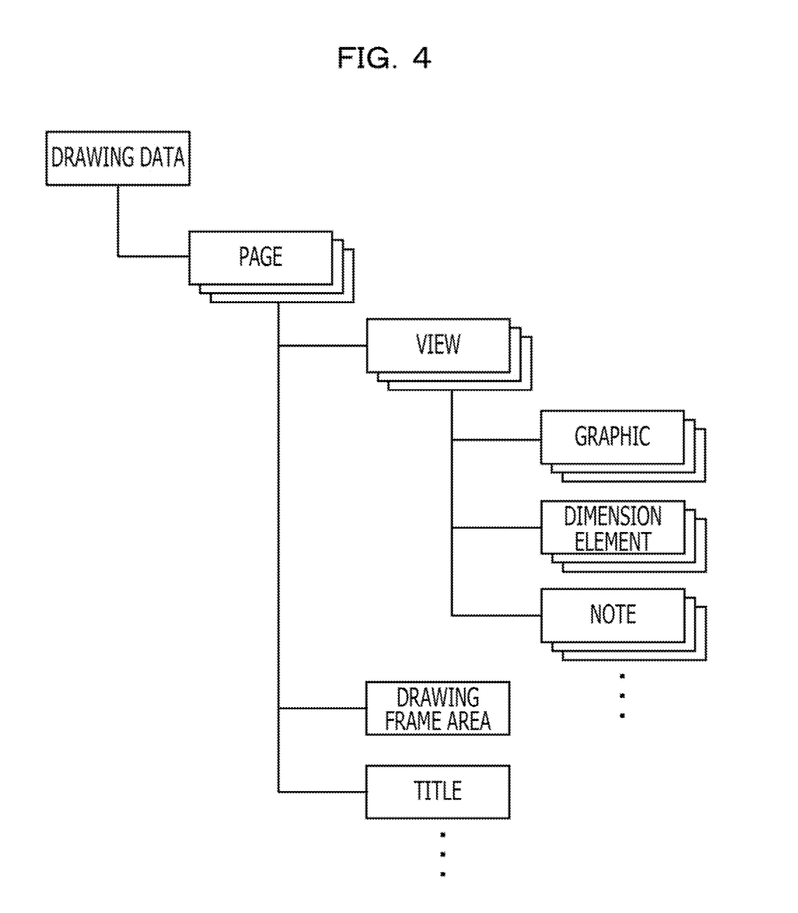

FIG. 4 illustrates an example of the data structure of drawing data according to an embodiment of the present invention. As illustrated in FIG. 4, one piece of drawing data includes one or more pages. Each page is a drawing element representing one drawing. One page includes, for example, one or more views, a drawing frame area, and a title. The view is a drawing element defined for every figure of an object represented by the drawing, viewed from a certain direction. Accordingly, for example, the page in which one front view and one side view are drawn includes two views. One view includes, for example, one or more graphics, dimension elements, and notes. Each graphic is a drawing element indicating the shape of the object. Each dimension element is a drawing element indicating a dimension value, a dimension line, or an extension line. Each note is, for example, an explanatory item that is arbitrarily described.

In order to further clarify the drawing frame area, the title, and the view, an example of how drawing data is displayed will now be illustrated.

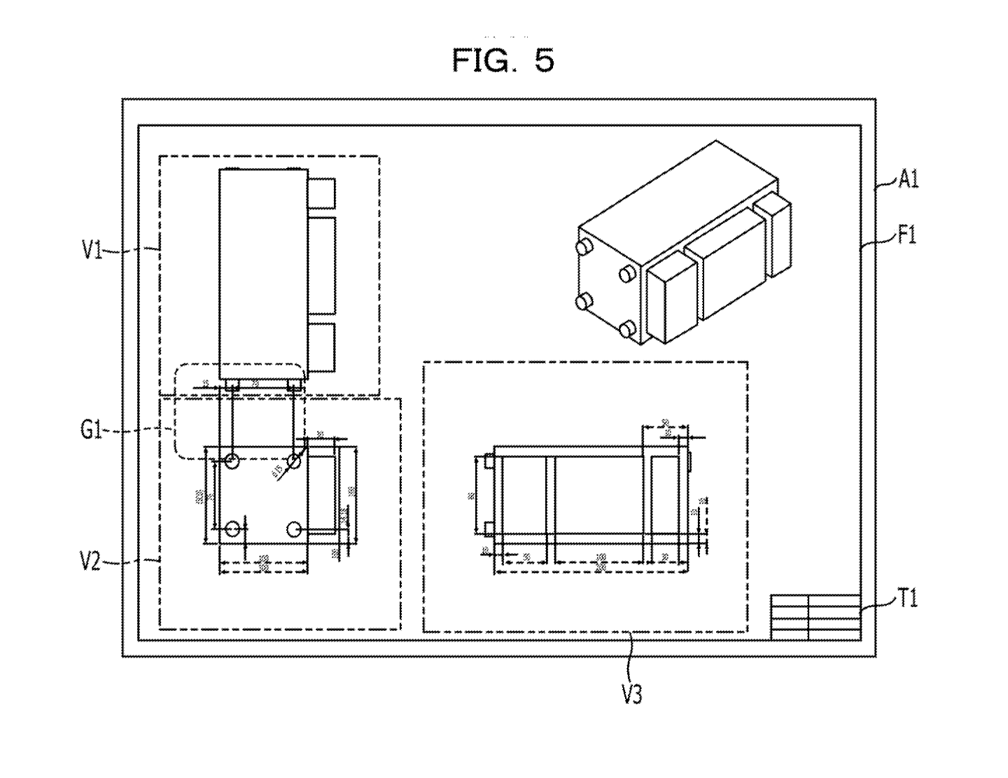

FIG. 5 illustrates an example of how drawing data is displayed. An example of how one page in drawing data is displayed is illustrated in FIG. 5. Referring to FIG. 5, a rectangular area denoted by A1 represents the drawing area (drawing range) in the page. A rectangular area denoted by F1 represents a frame line. The drawing area outside the frame line F1 in the drawing area A1 represents the drawing frame area, which is one drawing element. A rectangular area denoted by T1 is the title, which is one drawing element.

The page in FIG. 5 includes a view V1 in which a top view is drawn, a view V2 in which a front view is drawn, and a view V3 in which a side view is drawn. The drawing data may be displayed or may not be displayed in Step S110.

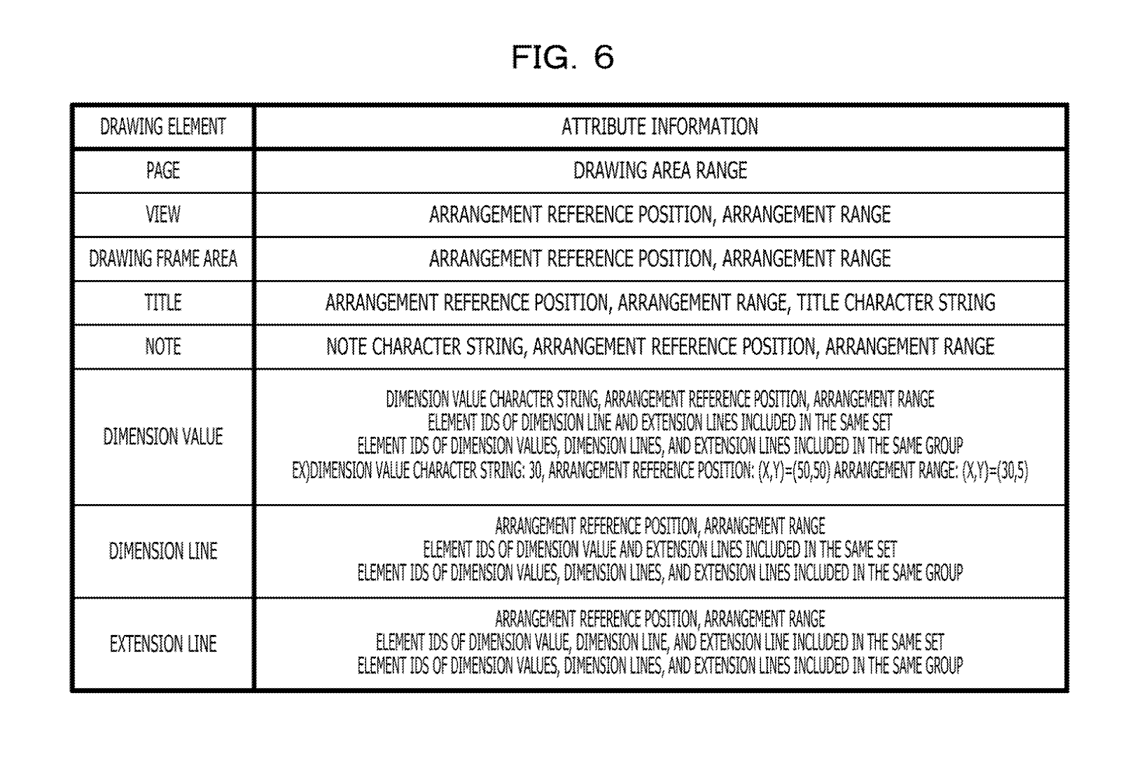

Each drawing element has, for example, attribute information illustrated in FIG. 6. FIG. 6 illustrates examples of the attribute information about each drawing element.

The page has a drawing area range as the attribute information. The drawing area range is coordinate information (for example, the coordinate values of four apices or two diagonal points) indicating the range of the drawing area.

The view has, for example, an arrangement reference position and an arrangement range as the attribute information. The arrangement reference position indicates the coordinate value of a view reference point (for example, a lower left apex of the view) in the drawing area. The arrangement range is size information (for example, a height and a width) indicating the range of the area of the view.

The drawing frame area has, for example, an arrangement reference position and an arrangement range as the attribute information. The arrangement reference position indicates the coordinate value of a reference point of the frame line (for example, a lower left apex of the frame line) in the drawing area. The arrangement range is size information indicating the range of the frame line.

The title has, for example, an arrangement reference position, an arrangement range, and a title character string as the attribute information. The arrangement reference position indicates the coordinate value of a reference point of the title (for example, a lower left apex of the title) in the drawing area. The arrangement range is size information indicating the range of the title. The title character string is a character string of the title.

The note has, for example, a note character string, an arrangement reference position, and an arrangement range as the attribute information. The note character string is a character string of the note. The arrangement reference position indicates the coordinate value of a reference point of a rectangular area (hereinafter referred to as a “note area”) surrounding the note character string in the drawing area (the reference point is, for example, a lower left apex of the note area). The arrangement range is size information indicating the range of the note area.

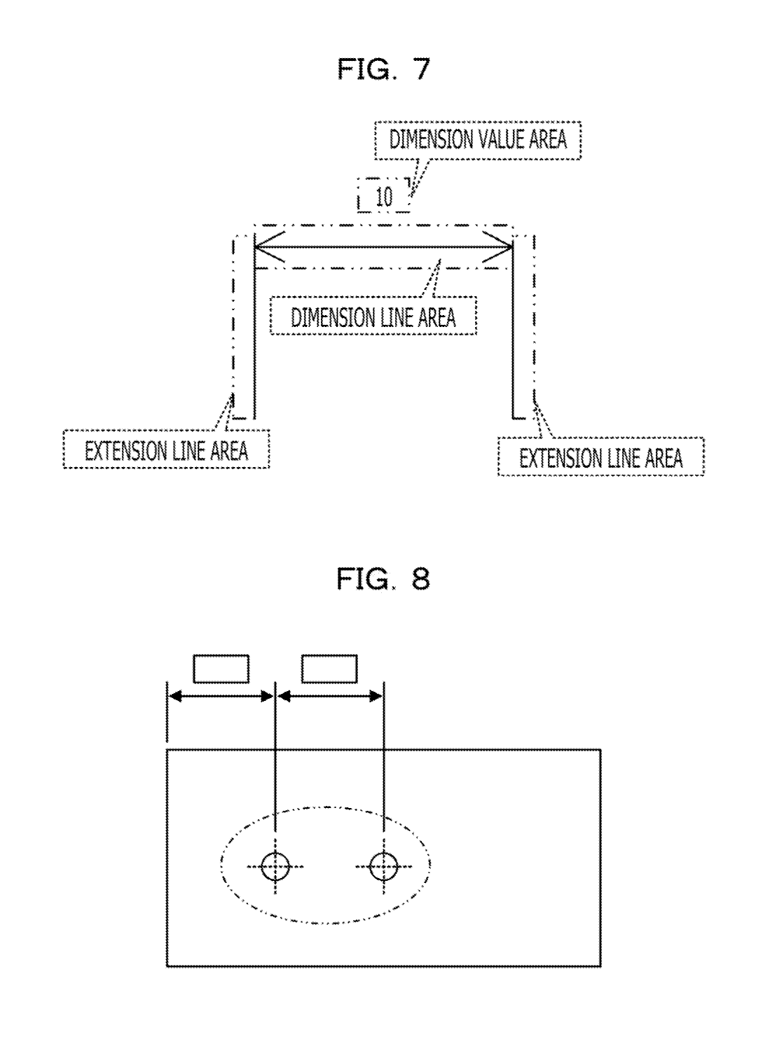

The dimension value has, for example, a dimension value character string, an arrangement reference position, and an arrangement range; element identifications (IDs) of a dimension line and extension lines included in the same set as that of the dimension value; and element IDs of dimension values, dimension lines, and extension lines included in the same group as that of the dimension value as the attribute information. The element IDs of a dimension line and extension lines included in the same set as that of the dimension value are the element IDs of a dimension line and extension lines associated with the dimension value. Specifically, each dimension element, such as the dimension value, the dimension line, or the extension line, is not arranged by itself and, normally, one dimension value, one dimension line, and two extension lines form one set, as illustrated in FIG. 7. The element IDs of a dimension line and extension lines included in the same set as that of the dimension value are the attribute information used for determining the set. Each drawing element has an ID for identifying the drawing element as the attribute information, although not illustrated in FIG. 6. Such an ID is referred to as the element ID in the present embodiment.

The dimension value character string is a character string of the dimension value. The arrangement reference position indicates the coordinate value of a reference point of a rectangular area (hereinafter referred to as a “dimension value area”: refer to FIG. 7) surrounding the dimension value character string in the drawing area (the reference point is, for example, a lower left apex of the dimension value area). The arrangement range is size information indicating the range of the dimension value area.

The element IDs of dimension values, dimension lines, and extension lines included in the same group as that of the dimension value are the element IDs of the dimension elements forming one group along with the dimension value. The group of dimension elements is a unit in which one or more sets of dimension elements are processed in an integrated manner.

FIG. 8 illustrates an example of a group of dimension elements. In such a case illustrated in FIG. 8, it is desirable to process two dimension values, two dimension lines, and three extension lines in an integrated manner. The dimension elements having such relationship are grouped and the element IDs of the other dimension elements are set in the attribute information about each dimension element. The element IDs of dimension values, dimension lines, and extension lines included in the same group as that of the dimension value are the attribute information for such grouping.

The dimension line has, for example, an arrangement reference position and an arrangement range; element IDs of a dimension value and extension lines included in the same set as that of the dimension line; and element IDs of dimension values, dimension lines, and extension lines included in the same group the dimension line as the attribute information. The arrangement reference position indicates the coordinate value of a reference point of a rectangular area (hereinafter referred to as a “dimension line area”: refer to FIG. 7) surrounding the dimension line in the drawing area (the reference point is, for example, a lower left apex of the dimension line area). The arrangement range is size information indicating the range of the dimension line area. Since the attribute information concerning the same set and the same group is apparent from the description of the attribute information about the dimension value, a description is omitted herein.

The extension line has, for example, an arrangement reference position and an arrangement range; element IDs of a dimension value, a dimension line, and an extension line included in the same set as the extension line; and element IDs of dimension values, dimension lines, and extension lines included in the same group as that of the extension line as the attribute information. The arrangement reference position indicates the coordinate value of a reference point of a rectangular area (hereinafter referred to as an “extension line area”: refer to FIG. 7) including the extension line in the drawing area (the reference point is, for example, an extension point of the extension line). The arrangement range is size information indicating the range of the extension line area. Since the attribute information concerning the same set and the same group is apparent from the description of the attribute information about the dimension value, a description is omitted herein. One extension line forms one drawing element.

Referring back to FIG. 3, in Step S120, the drawing data acquirer 11 sets the first page of the drawing data to be processed (hereinafter referred to as “current drawing data”) as the processing target (such a page is hereinafter referred to as a “current page”). In Step S130, the drawing area divider 12 divides the drawing area of the current page into unit areas on the basis of the drawing area range of the current page.

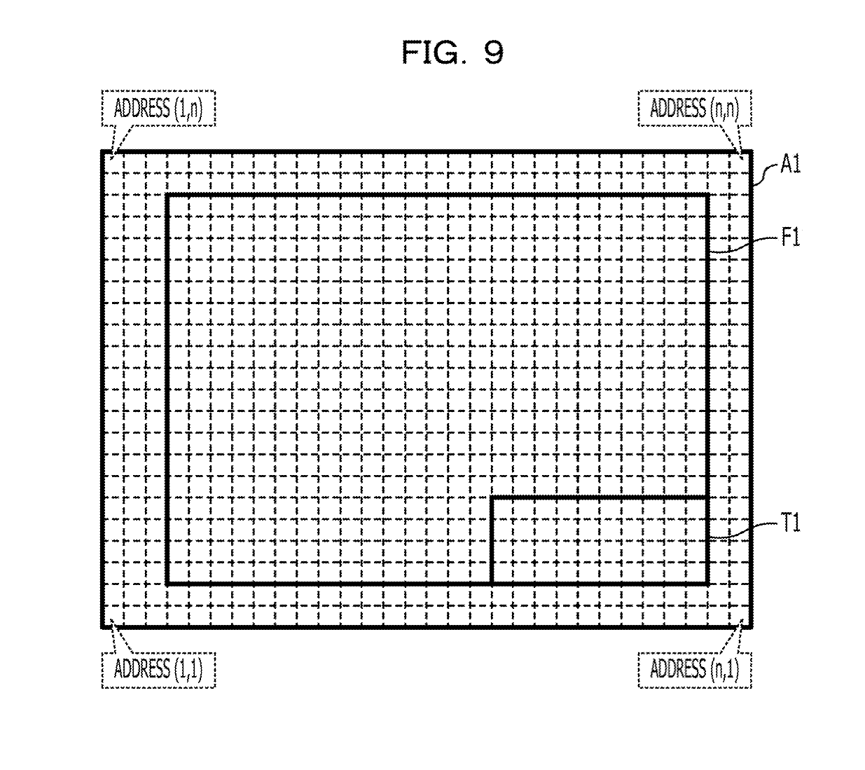

FIG. 9 illustrates an example of a drawing area divided into unit areas. The same reference numerals are used in FIG. 9 to identify the same components in FIG. 5. Referring to FIG. 9, the rectangles in a minimum unit are the unit areas. The drawing area divider 12 gives positional information (identification information) to each unit area that is generated. The positional information is represented by an address with respect to the lower left corner of the drawing area A1 in the present embodiment. The address is denoted in a format (column number, line number).

The size of the unit area (for example, the length of a side) may be edited in, for example, a setting file or may be fixed. The size of the unit area is preferably set so that the respective drawing elements are covered with multiple unit areas. The unit area has a rectangular shape in the present embodiment. However, the unit area may have another shape (for example, a hexagonal shape). Although the boundary between the frame line F1 and the title T1 is also used as the boundary between the unit areas for convenience in FIG. 9, the division of the unit areas is not intended in such a manner. In other words, the division of the unit areas is not affected by the arrangement of the drawing elements.

Referring back to FIG. 3, in Step S140, the unit area allocator 13 allocates (associates) the unit areas belonging to (positioned in) the drawing frame area and the area of the title in the current page to (with) the drawing frame area and the title. In Step S150, the unit area allocator 13 allocates the unit areas belonging to the area of each view in the current page to the view. In Step S160, the unit area allocator 13 allocates the unit areas belonging to the areas of each dimension element and each note in the current page to the dimension element and the note. The addresses of the allocated unit areas and association information are recorded in the memory unit 103 for every drawing element as the processing result of Steps S140, S150, and S160.

In Step S170, the interference determiner 14 determines whether the interference occurs between the drawing elements on the basis of the presence of the duplication of the unit areas allocated to each drawing element. Specifically, the interference determiner 14 determines that the interference occurs between the drawing elements to which the same unit area is allocated. The arrangement position corrector 15 corrects the positions where the drawing elements determined to have the interference are arranged.

In Step S180, the drawing data acquirer 11 determines whether the next page exists in the current drawing data. If the next page exists in the current drawing data (Yes in Step S180), then in Step S190, the drawing data acquirer 11 sets the next page as the processing target (as the current page). Then, Steps S130 to S170 are performed for the next page.

If the process is completed for all the pages included in the current drawing data (No in Step S180), then in Step S210, the drawing data acquirer 11 writes the drawing data corrected in the memory unit 103 into the drawing DB 16.

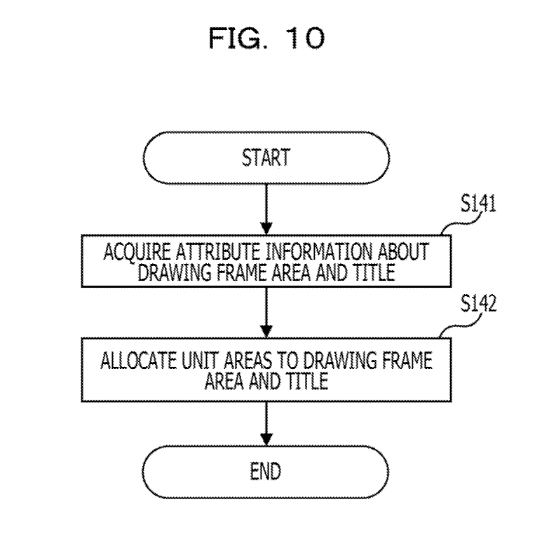

The processing in Step S140 will now be described in detail. FIG. 10 illustrates an example of a process of allocating the unit areas to the drawing frame area and the title.

Referring to FIG. 10, in Step S141, the unit area allocator 13 acquires the attribute information about the drawing frame area and the title included in the current page from the drawing data. In Step S142, the unit area allocator 13 determines the areas of the drawing frame area and the title on the basis of the arrangement reference position and the arrangement range thereof and allocates the addresses of the unit areas belonging to the respective areas to the drawing frame area or the title. The unit areas belonging to the areas of the drawing frame area and the title include not only the unit areas all of which are included in the areas but also the unit areas part of which is included in the areas. The same applies to the determination of the unit areas belonging to the other drawing elements. The coordinate information about each unit area in the drawing area may be calculated on the basis of the address of each unit area and the size information about each unit area. Alternatively, upon generation of each unit area, the coordinate information may be associated with the unit area.

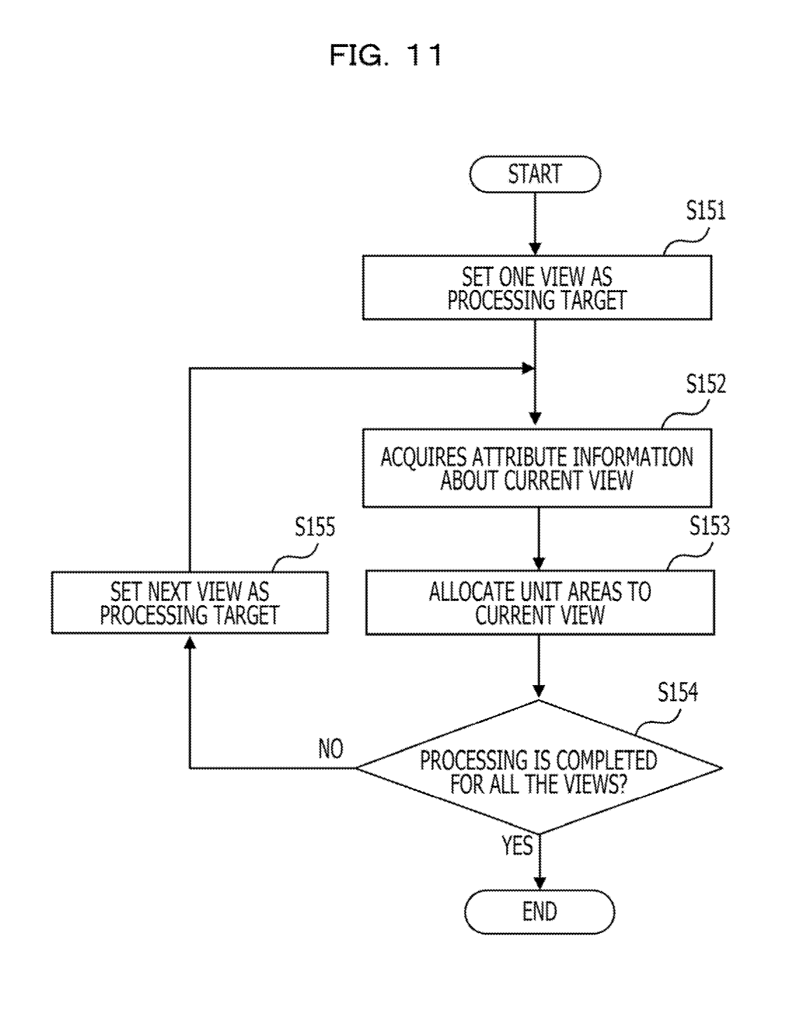

The processing in Step S150 will now be described in detail. FIG. 11 illustrates an example of a process of allocating the unit areas to the view.

Referring to FIG. 11, in Step S151, the unit area allocator 13 sets one view included in the current page as the processing target (this view is hereinafter referred to as a “current view”). In Step S152, the unit area allocator 13 acquires the attribute information about the current view from the drawing data. In Step S153, the unit area allocator 13 determines the area of the current view on the basis of the arrangement reference position and the arrangement range of the current view and allocates the addresses of the unit areas belonging to the area to the current view. In Step S154, the unit area allocator 13 determines whether the processing is completed for all the views included in the current page. If the unit area allocator 13 determines that a view that is not processed remains in the current page (No in Step S154), then in Step S155, the unit area allocator 13 sets the view that is not processed as the processing target. Then, Steps S152 and S153 are repeated. If the unit area allocator 13 determines that the processing is completed for all the views included the current page (Yes in Step S154), the process in FIG. 11 is terminated.

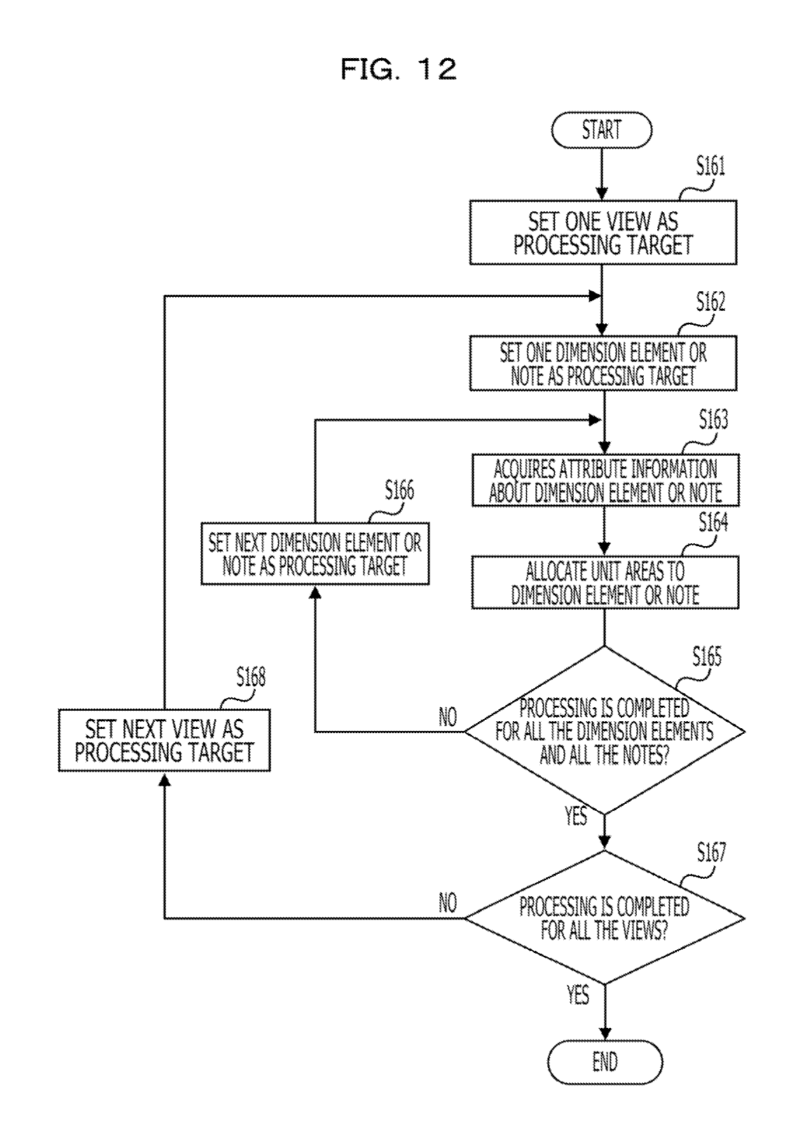

The processing in Step S160 will now be described in detail. FIG. 12 illustrates an example of a process of allocating the unit areas to the dimension element and the note.

Referring to FIG. 12, in Step S161, the unit area allocator 13 sets one view included in the current page as the processing target (this view is hereinafter referred to as a “current view”). In Step S162, the unit area allocator 13 sets one dimension element (one dimension value, one dimension line, or one extension line) or one note included in the current view as the processing target (this dimension element or note is hereinafter referred to as a “current drawing element”).

In Step S163, the unit area allocator 13 acquires the attribute information about the current drawing element from the drawing data. In Step S164, the unit area allocator 13 allocates the addresses of the unit areas belonging to the area of the current drawing element to the current drawing element.

For example, when the current drawing element is a dimension value, the unit areas are allocated to the dimension value.

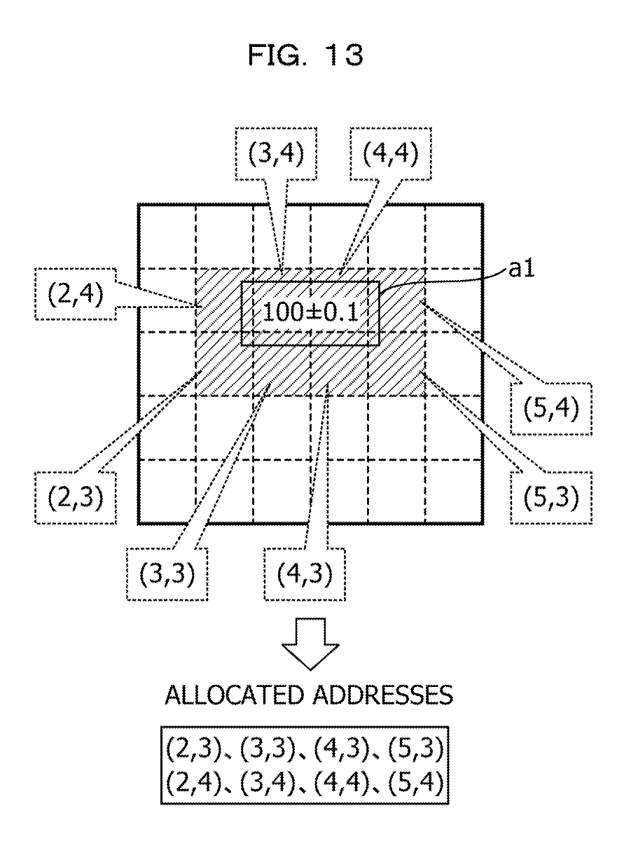

FIG. 13 illustrates an example of how the addresses of unit areas are allocated to a dimension value. In the example in FIG. 13, eight unit areas are overlapped with at least part of a dimension value area a1. Accordingly, in this case, the addresses of the eight unit areas are allocated to the dimension value. The dimension value area a1 is identified on the basis of the arrangement reference position and the arrangement range, which is the attribute information about the dimension value.

When the current drawing element is a dimension line, the unit areas are allocated to the dimension line.

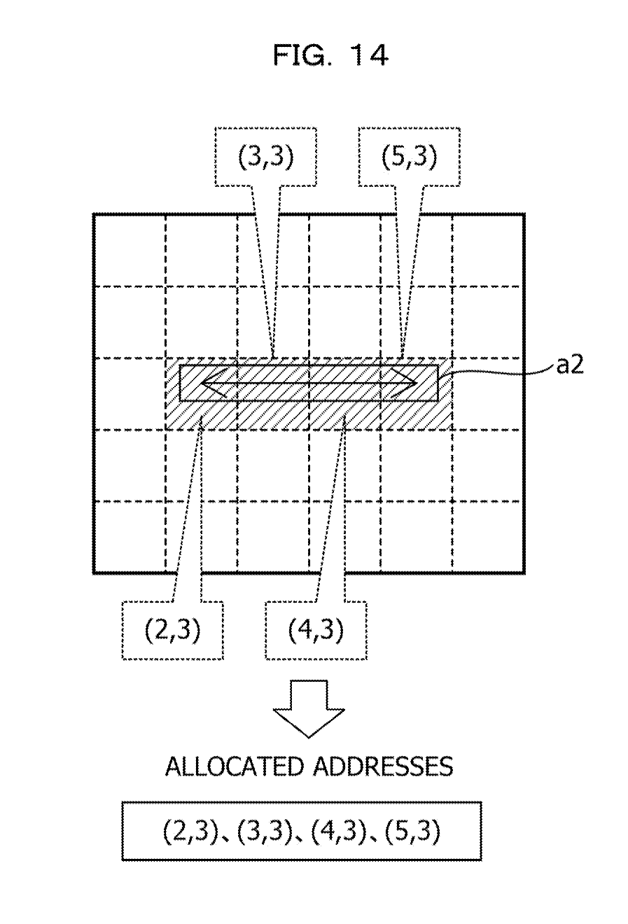

FIG. 14 illustrates an example of how the addresses of unit areas are allocated to a dimension line. In the example in FIG. 14, four unit areas are overlapped with at least part of a dimension line area a2. Accordingly, in this case, the addresses of the four unit areas are allocated to the dimension line. The dimension line area a2 is identified on the basis of the arrangement reference position and the arrangement range, which is the attribute information about the dimension line.

When the current drawing element is an extension line, the unit areas are allocated to the extension line.

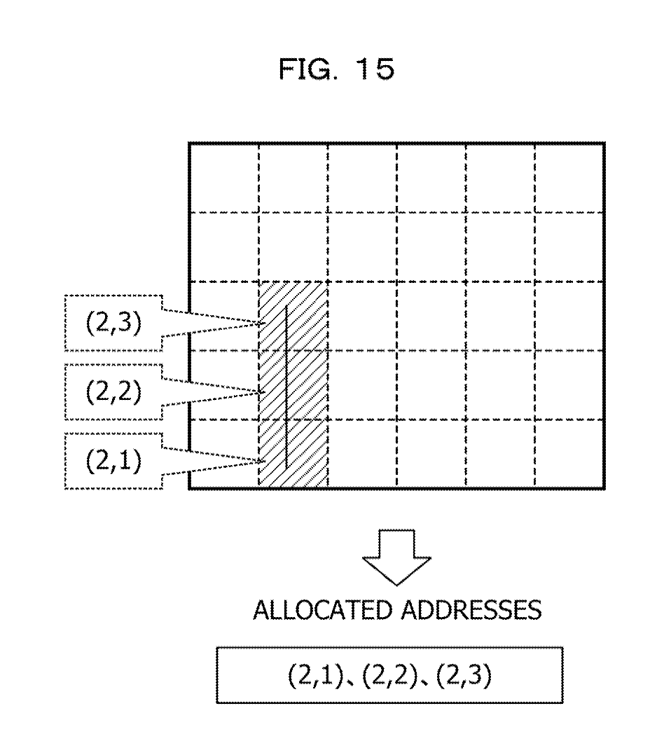

FIG. 15 illustrates an example of how the addresses of unit areas are allocated to an extension line. In the example in FIG. 15, three unit areas are overlapped with at least part of the extension line area. Accordingly, in this case, the addresses of the three unit areas are allocated to the extension line. The extension line area is identified on the basis of the arrangement reference position and the arrangement range, which is the attribute information about the extension line. However, the range of the extension line area is not drawn in FIG. 15 for convenience.

When the current drawing element is a note, the addresses of unit areas overlapped with at least part of the note area defined by the arrangement reference position and the arrangement range of the note are allocated to the note.

Referring back to FIG. 12, in Step S165, the unit area allocator 13 determines whether the processing is completed for all the dimension elements and all the notes included in the current view. If the unit area allocator 13 determines that a dimension element or a note that is not processed remains (No in Step S165), then in Step S166, the unit area allocator 13 sets the dimension element or the note that is not processed as the processing target. Then, Steps S163 and S164 are repeated. If the unit area allocator 13 determines that the processing is completed for all the dimension elements and all the notes included in the current view (Yes in Step S165), then in Step S167, the unit area allocator 13 determines whether the processing is completed for all the views included in the current page. If the unit area allocator 13 determines that a view that is not processed remains in the current page (No in Step S167), then in Step S168, the unit area allocator 13 sets the view that is not processed as the processing target. Then, Step S162 and the subsequent steps are repeated. If the unit area allocator 13 determines that the processing is completed for all the views included in the current page (Yes in Step S167), the process in FIG. 12 is terminated.

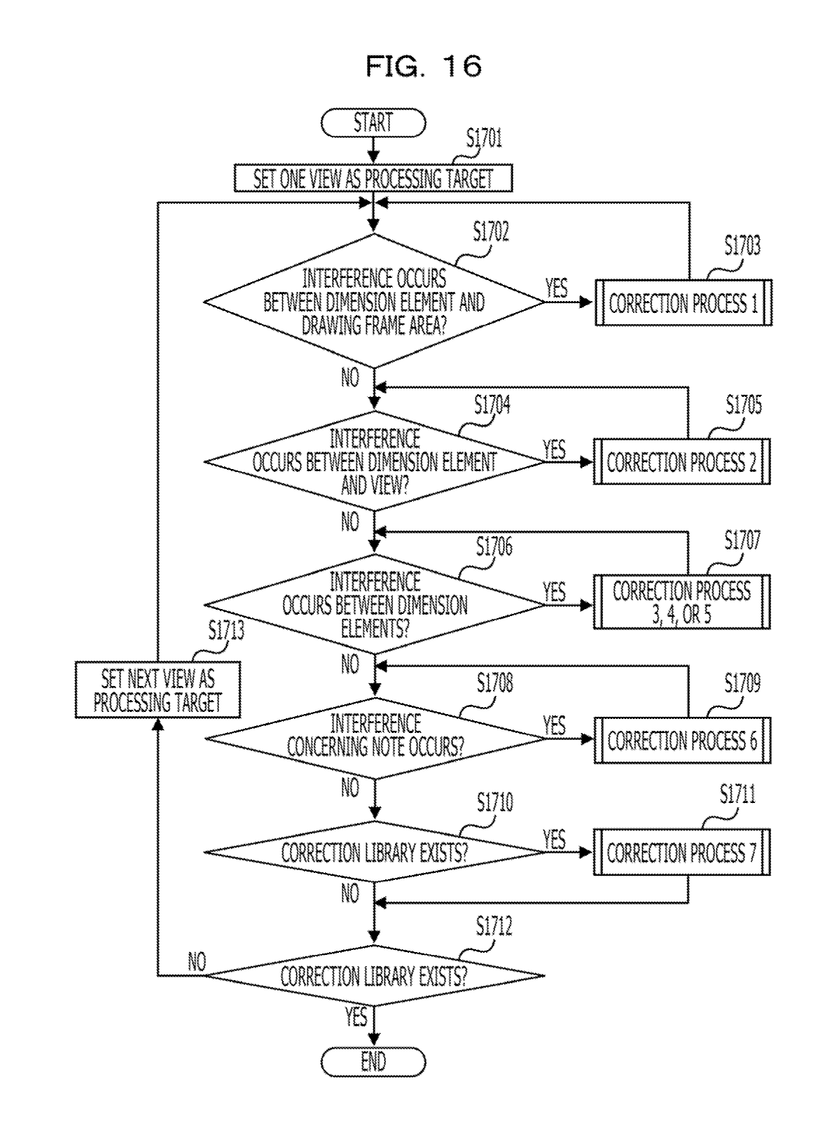

The processing in Step S170 will now be described in detail. FIG. 16 illustrates an example of a process of determining the interference between drawing elements and correcting the arrangement position.

Referring to FIG. 16, in Step S1701, the interference determiner 14 sets one view included in the current page as the processing target (this view is hereinafter referred to as a “current view”). In Step S1702, the interference determiner 14 determines whether the interference occurs between a dimension element and the drawing frame area in the current view. In other words, the interference determiner 14 determines whether part or all of a dimension element protrudes from the frame line. The presence of the interference is based on whether the addresses of the unit areas allocated to the dimension element are duplicated with the addresses of the unit areas allocated to the drawing frame area.

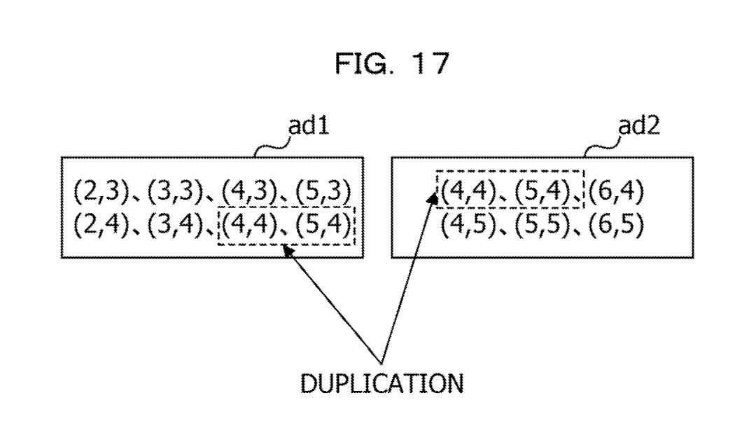

FIG. 17 illustrates an example of how to determine whether the interference occurs between drawing elements on the basis of the addresses of unit areas. Referring to FIG. 17, address information ad1 is part of the address allocated to the drawing frame area and address information ad2 is the address allocated to one dimension element. In this case, an address (4, 4) and address (5, 4) are duplicated between the address information ad1 and the address information ad2. Accordingly, it is determined that the interference occurs between the dimension element and the drawing frame area. If no address is duplicated, it is determined that no interference occurs between the drawing elements. The determination method in FIG. 17 is also applied to the determination of whether the interference occurs between the other drawing elements.

The presence of the interference between the drawing frame area and all the dimension elements included in the current page is sequentially determined in Step S1702. Each time the interference is detected (Yes in Step S1702), in Step S1703, the arrangement position corrector 15 performs a process of correcting the arrangement position of the dimension elements concerning or involving in the interference (Correction process 1).

If the interference between the dimension elements in the current view and the drawing frame area is eliminated (No in Step S1702), then in Step S1704, the interference determiner 14 determines whether the interference occurs between a dimension element in the current view and a view other than the current view on the basis of the addresses of the unit areas allocated to the dimension element and the view. Specifically, the presence of the interference between each dimension element in the current view and the views to which the dimension element does not belong is sequentially determined in Step S1704. Each time the interference is detected (Yes in Step S1704), in Step S1705, the arrangement position corrector 15 performs a process of correcting the arrangement position of the dimension elements concerning or involving in the interference (Correction process 2).

If the interference between the dimension elements in the current view and the views other than the current view is eliminated (No in Step S1704), then in Step S1706, the interference determiner 14 determines whether the interference occurs between the dimension elements in the current view on the basis of the addresses of the unit areas allocated to the dimension elements. Each time the interference is detected (Yes in Step S1706), in Step S1707, the arrangement position corrector 15 performs a process of correcting the arrangement position of the dimension elements concerning or involving in the interference (Correction process 3, 4, or 5).

If the interference between the dimension elements in the current view is eliminated (No in Step S1706), then in Step S1708, the interference determiner 14 determines whether the interference occurs between each note in the current view and other drawing elements on the basis of the addresses of the unit areas allocated to the note and the drawing elements. Each time the interference is detected (Yes in Step S1708), in Step S1709, the arrangement position corrector 15 performs a process of correcting the arrangement position of the note concerning the interference (Correction process 6).

If the interference concerning the notes in the current view is eliminated (No in Step S1708), then in Step S1710, the interference determiner 14 determines whether a correction library exists. The correction library is information used to realize a correction rule that concerns automatic correction of the arrangement positions of the drawing elements and that is specific to the user. The correction library includes interference pattern data and correction pattern data. The interference pattern data is data in which the state (interference pattern) of a drawing element that should be determined to have the interference is defined. The correction pattern data is data in which the content of correction corresponding to the interference pattern is defined. The interference pattern data and the correction pattern data are stored in the auxiliary storage unit 102 as, for example, a file.

If the correction library exists (Yes in Step S1710), then in Step S1711, the arrangement position corrector 15 performs a correction process (Correction process 7) based on the correction library.

In Step S1712, the interference determiner 14 determines whether the processing is completed for all the views included in the current page. If the interference determiner 14 determines that a view that is not processed remains in the current page (No in Step S1712), then in Step S1713, the interference determiner 14 sets the view that is not processed as the processing target. Then, Step S1702 and the subsequent steps are repeated. If the interference determiner 14 determines that the processing is completed for all the views included in the current page (Yes in Step S1712), the process in FIG. 16 is terminated.

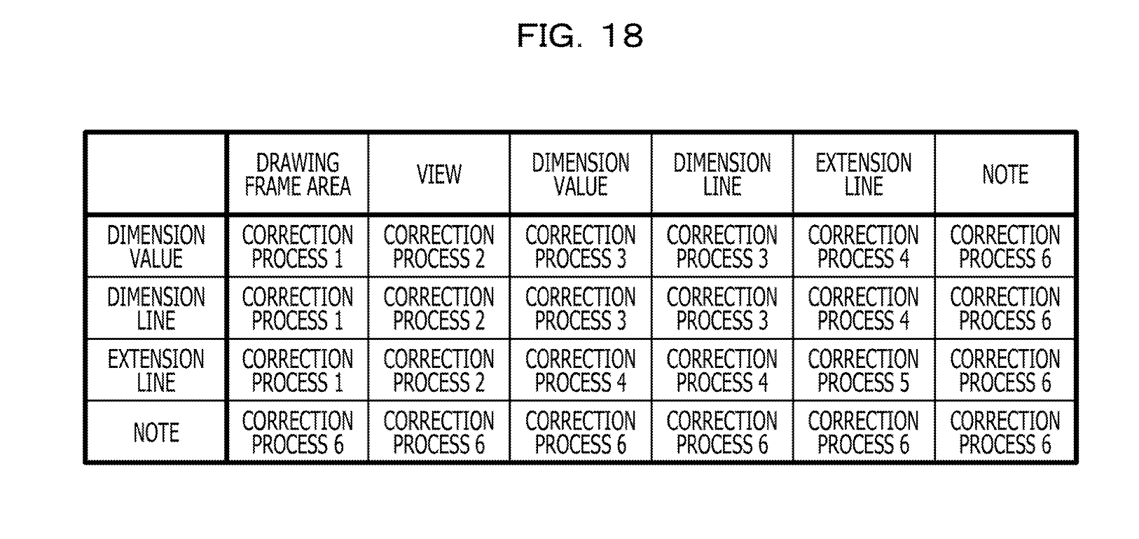

The content of processing in FIG. 16 is summarized in a table in FIG. 18. FIG. 18 illustrates examples of the correction processes that are performed in association with the types of the drawing elements that interfere with each other. The correction processes that are performed when the drawing elements (the dimension value, the dimension line, the extension line, and the note) in the row direction interfere with the drawing elements (the drawing frame area, the view (the view to which the drawing element does not belong), the dimension value, the dimension line, the extension line, and the note) in the column direction are illustrated in FIG. 18. The content of the correction processes 1 to 6 in FIG. 18 coincides with the content of the correction processes 1 to 6 in FIG. 16. As illustrated in FIG. 18, the process that is performed is varied depending on the types of the drawing elements interfering with each other.

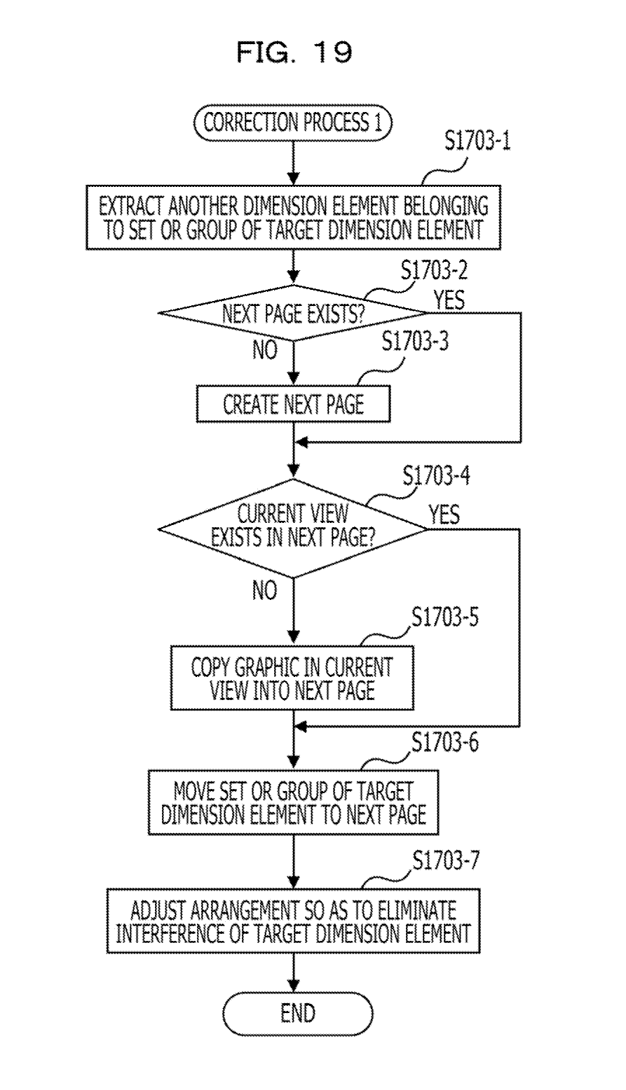

Correction processes 1 to 7 will now be sequentially described in detail. FIG. 19 illustrates Correction process 1 in detail.

Referring to FIG. 19, in Step S1703-1, the arrangement position corrector 15 extracts another dimension element belonging to the set or group of the dimension element (target dimension element) for which the interference with the drawing frame area is detected. Specifically, the element ID of a dimension element belonging to the set or group is identified on the basis of the attribute information about the target dimension element.

In Step S1703-2, the arrangement position corrector 15 determines whether the page next to the current page (hereinafter simply referred to as a “next page”) exists on the basis of the drawing data. If the arrangement position corrector 15 determines that the next page exists (Yes in Step S1703-2), the process goes to Step S1703-4. If the arrangement position corrector 15 determines that the next page does not exist (No in Step S1703-2), then in Step S1703-3, the arrangement position corrector 15 adds the next page to the drawing data. In Step S1703-4, the arrangement position corrector 15 determines whether the current view exists in the next page on the basis of the drawing data. In other words, it is determined whether the drawing element having the same element ID as that of the current view exists in the next page. If the arrangement position corrector 15 determines that the current view exists in the next page (Yes in Step S1703-4), the process goes to Step S1703-6. If the arrangement position corrector 15 determines that the current view does not exist in the next page (No in Step S1703-4), then in Step S1703-5, the arrangement position corrector 15 copies the current view and the graphic in the current view into the next page. The graphic in the current view is also copied in order to include the graphic corresponding to the dimension element in the next page. In other words, the drawing element that is copied into the next page, among the drawing elements included in the current view, may be only the graphic whose dimensions are indicated by the dimension elements belonging to the set or group of the target dimension element. However, if the association between the dimension elements and the graphics is not held as data, all the graphics in the current view may be copied into the next page.

In Step S1703-6, the arrangement position corrector 15 moves the target dimension element and the dimension elements belonging to the same set or group as that of the target dimension element to the next page. As a result, the dimension elements belonging to the set or group are deleted from the current page in the drawing data. In Step S1703-7, the arrangement position corrector 15 moves the target dimension element to a position that does not interfere with the drawing frame area of the next page. Determination of whether the destination of the target dimension element interferes with the drawing frame area of the next page may also be based on the presence of the duplication of the unit areas resulting from the division of the next page. The shapes of other dimension elements belonging to the set or group of the target dimension element may be varied in accordance with the movement of the target dimension element. For example, the position of the dimension line may be varied and the length of the extension lines may also be varied in accordance with the change in the position of the dimension value.

Correction process 2 will now be described in detail. Correction process 2 is performed in a manner similar to that of Correction process 1 except that the dimension element to be processed is a dimension element for which the interference with a view other than the current view is detected.

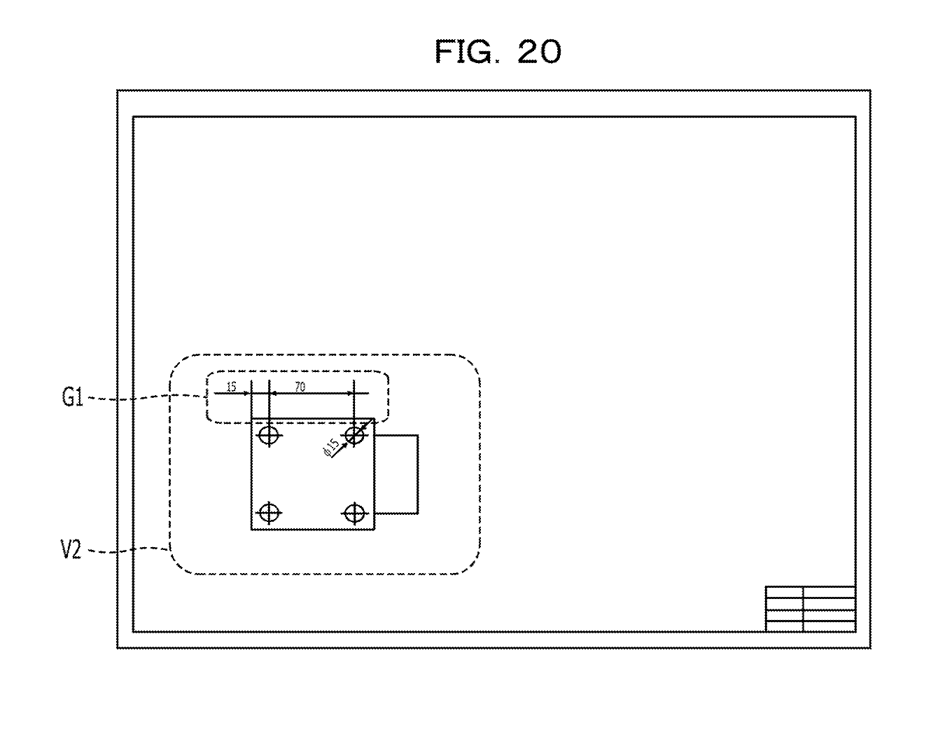

For example, in the example in FIG. 5, the dimension element that is included in the view V2 and that forms a group G1 interferes with the view V1. Accordingly, the group G1 is moved to the next page as the result of Correction process 2 and the next page results in a state illustrated in FIG. 20.

FIG. 20 illustrates an example including the view that is copied into the next page and the dimension elements that are moved to the next page. In the example in FIG. 20, the view V2 and the graphics included in the view V2 are copied into the next page and the group G1 that interferes with the view V1 is moved to the next page. As in the example illustrated in FIG. 20, the drawing elements (for example, the dimension elements that are not in the group G1) other than the graphics included in the view V2 may not be copied into the next page.

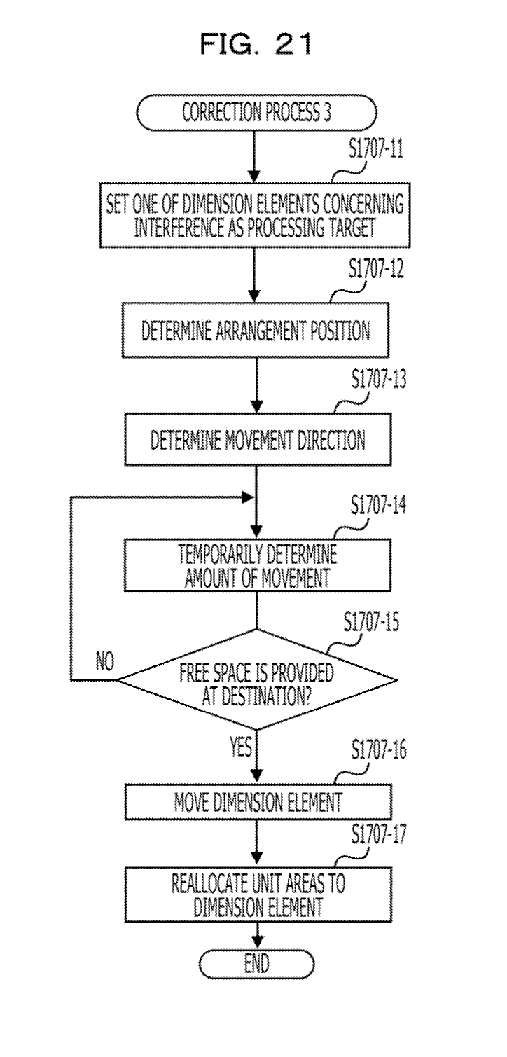

Correction process 3 will now be described in detail. FIG. 21 illustrates Correction process 3 in detail. Correction process 3 is performed when a dimension value or a dimension line interferes with another dimension value or dimension line (refer to FIG. 18). Accordingly, the dimension element in the description with reference to FIG. 21 is limited to a dimension value or a dimension line.

Referring to FIG. 21, in Step S1707-11, the arrangement position corrector 15 sets one of the dimension elements for which the interference is detected as the processing target (target dimension element). In Step S1707-12, the arrangement position corrector 15 determines a relative arrangement position of the target dimension element with respect to a target graphic. In Step S1707-13, the arrangement position corrector 15 determines the movement direction of the target dimension element on the basis of the result of the determination of the arrangement position of the target dimension element.

Steps S1707-12 and S1707-13 will now be described in detail.

FIG. 22 illustrates examples of relative arrangement positions with respect to a target graphic. In the example in FIG. 22, the target graphic is a rectangle R1 and dimension elements are arranged in four directions around the rectangle R1. It is determined in Step S1707-12 whether the target dimension element is arranged at a position d1 (upper), a position d2 (right), a position d3 (lower), or a position d4 (left) with respect to the rectangle R1.

The determination may be based on, for example, the coordinate value of the reference point of the dimension value included in the set of the target dimension element and the coordinate value of the reference point (extension point) of the extension line included in the set of the target dimension element.

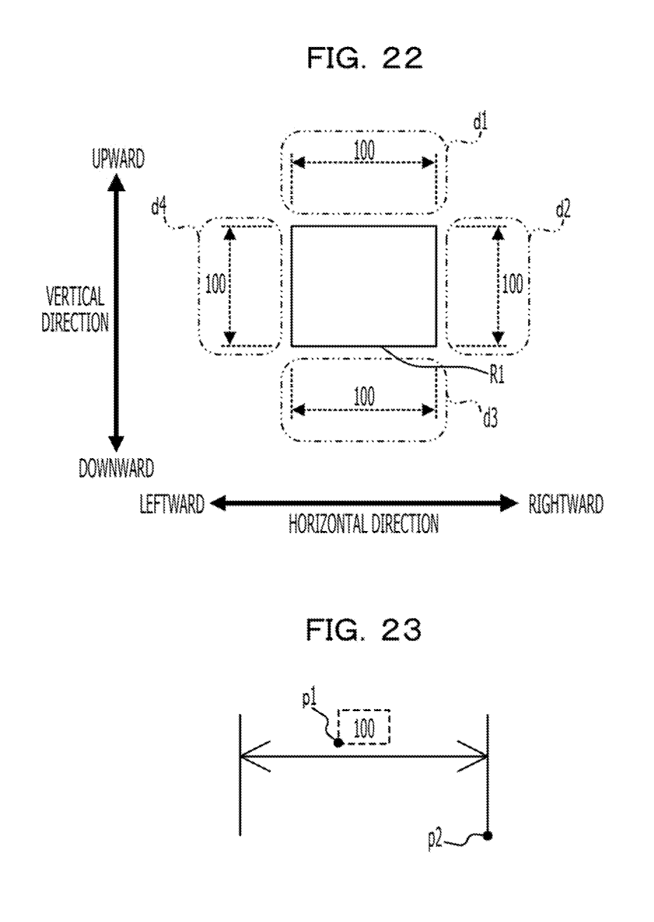

FIG. 23 illustrates an example of the relationship between a reference point of a dimension value and an extension point, e.g., an extension point on an extension line. When the dimension elements are arranged in the manner in FIG. 23, the coordinate value of a reference point p1 of the dimension value is compared with the coordinate value of an extension point p2. Although two extension lines are normally drawn, either of the two extension lines may be compared. In other words, the coordinate value of an extension point of a left extension line may be compared with the coordinate value of the reference point p1 in the example in FIG. 23.

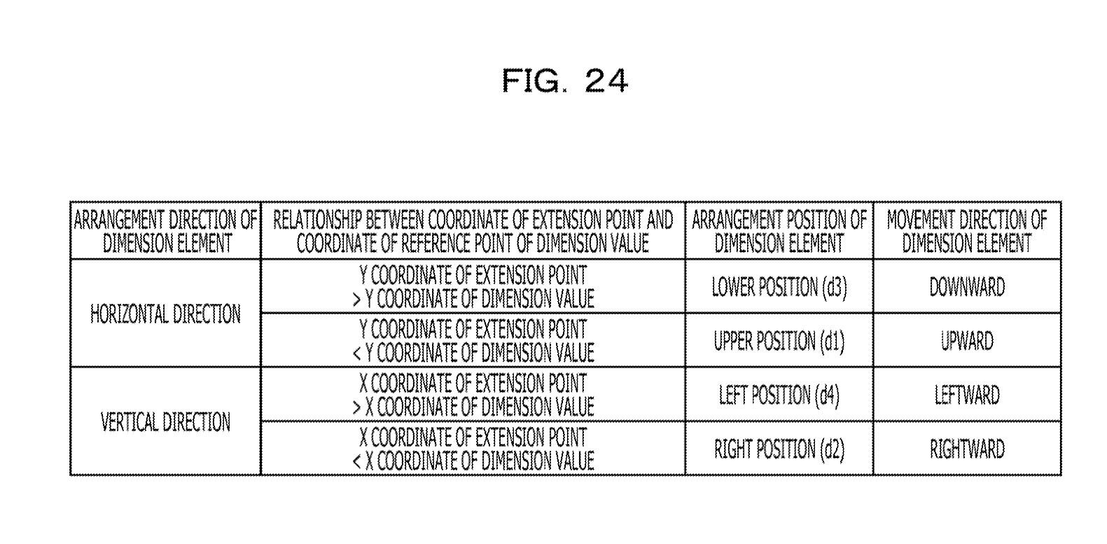

FIG. 24 is a table illustrating the content of determination of the relative arrangement position of the target dimension element with respect to the target graphic, based on the comparison between a reference point of a dimension value and an extension point.

The determination is sequentially performed in the order of the column direction in the table in FIG. 24. Specifically, the arrangement position corrector 15 determines whether the target dimension element is arranged at a horizontal position or a vertical position with respect to the target graphic (first column). The arrangement direction may be based on the arrangement range of the target dimension element. Alternatively, the attribute information indicating the arrangement direction may be added to each dimension element.

When the target dimension element is arranged at a horizontal position with respect to the target graphic, the arrangement position corrector 15 compares the coordinate of the extension point with the coordinate of the reference point of the target dimension element (second column). If the Y coordinate value of the extension point is larger than the Y coordinate value of the reference point of the dimension value, the arrangement position corrector 15 determines that the target dimension element is arranged at a lower position (the position d3 in FIG. 22) with respect to the target graphic (third column). As a result, the arrangement position corrector 15 determines that the target dimension element is moved downward (fourth column). If the Y coordinate value of the extension point is smaller than the Y coordinate value of the reference point of the dimension value, the arrangement position corrector 15 determines that the target dimension element is arranged at an upper position (the position d1 in FIG. 22) with respect to the target graphic (third column). As a result, the arrangement position corrector 15 determines that the target dimension element is moved upward (fourth column).

When the target dimension element is arranged at a vertical position with respect to the target graphic, the arrangement position corrector 15 compares the coordinate of the extension point with the coordinate of the reference point of the target dimension element (second column). If the X coordinate value of the extension point is larger than the X coordinate value of the reference point of the dimension value, the arrangement position corrector 15 determines that the target dimension element is arranged at a left position (the position d4 in FIG. 22) with respect to the target graphic (third column). As a result, the arrangement position corrector 15 determines that the target dimension element is moved leftward (fourth column). If the X coordinate value of the extension point is smaller than the X coordinate value of the reference point of the dimension value, the arrangement position corrector 15 determines that the target dimension element is arranged at a right position (the position d2 in FIG. 22) with respect to the target graphic (third column). As a result, the arrangement position corrector 15 determines that the target dimension element is moved rightward (fourth column).

Consequently, the target dimension element is moved in a direction opposite to the direction in which the target graphic is arranged.

Referring back to FIG. 21, in Step S1707-14, the arrangement position corrector 15 temporarily determines the amount of movement. For example, a value that is set in advance in the auxiliary storage unit 102 may be used as the amount of movement. In Step S1707-15, the arrangement position corrector 15 determines whether a free space sufficient to accommodate the target dimension element is provided at a position corresponding to the movement direction and the amount of movement that are determined. This determination may be based on the arrangement range of the target dimension element. In other words, it may be determined whether a free space that may contain the arrangement range is provided. If the arrangement position corrector 15 determines that a free space sufficient to accommodate the target dimension element is not provided (No in Step S1707-15), the process goes back to Step S1707-14 where the arrangement position corrector 15 performs fine adjustment of the amount of movement. In Step S1707-15, the arrangement position corrector 15 searches for a free space sufficient to accommodate the target dimension element.

If a free space sufficient to accommodate the target dimension element is found (Yes in Step S1707-15), then in Step S1707-16, the arrangement position corrector 15 determines the amount of movement and moves the target dimension element in the movement direction determined in Step S1707-13 by the amount of movement that is determined. The arrangement position corrector 15 also moves or modifies the other target dimension elements belonging to the set of the target dimension element along with the movement of the target dimension element. For example, when the target dimension element is a dimension value, the corresponding dimension line is also moved with the dimension value and the corresponding extension lines are extended. Accordingly, whether a free space sufficient to accommodate the other dimension elements that are moved or modified with the movement of the target dimension element is provided is also preferably determined in the determination of a free space in Step S1707-15. The movement or modification of the drawing elements including the dimension elements indicates changing of the values of the attribute information about the drawing elements.

In Step S1707-17, the arrangement position corrector 15 reallocates the unit areas to each dimension element that is moved or modified.

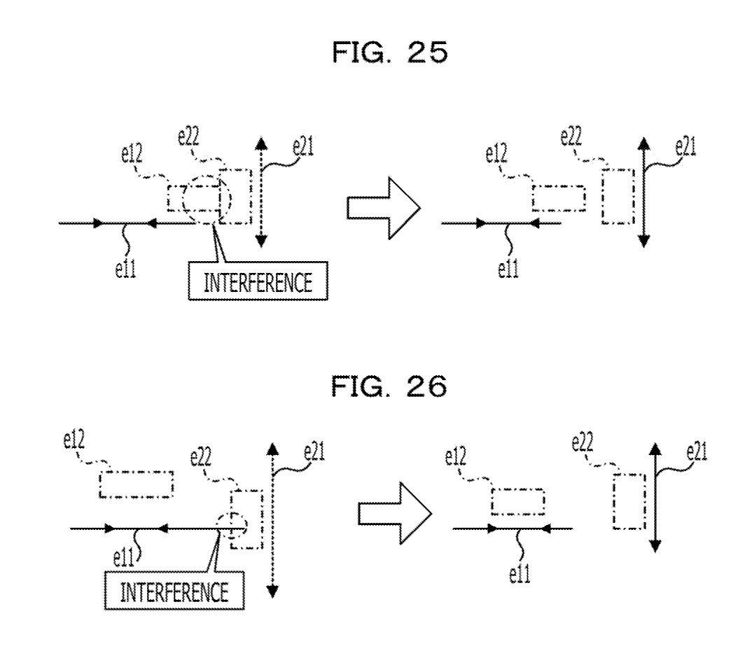

A specific example of Correction process 3 will now be described. FIG. 25 illustrates an example of how to correct the interference between dimension values. In the left figure in FIG. 25, a dimension value e12 interferes with a dimension value e22 in a set of a dimension line ell and the dimension value e12 and a set of a dimension line e21 and the dimension value e22. In this case, as illustrated in the right figure in FIG. 25, the dimension line e21 and the dimension value e22 are moved rightward to substantially eliminate the interference.

FIG. 26 illustrates an example of how to correct the interference between a dimension value and a dimension line. In the left figure in FIG. 26, the dimension line e11 interferes with the dimension value e22 in the set of the dimension line e11 and the dimension value e12 and the set of the dimension line e21 and the dimension value e22. In this case, as illustrated in the right figure in FIG. 26, the dimension line e21 and the dimension value e22 are moved rightward to substantially eliminate the interference.

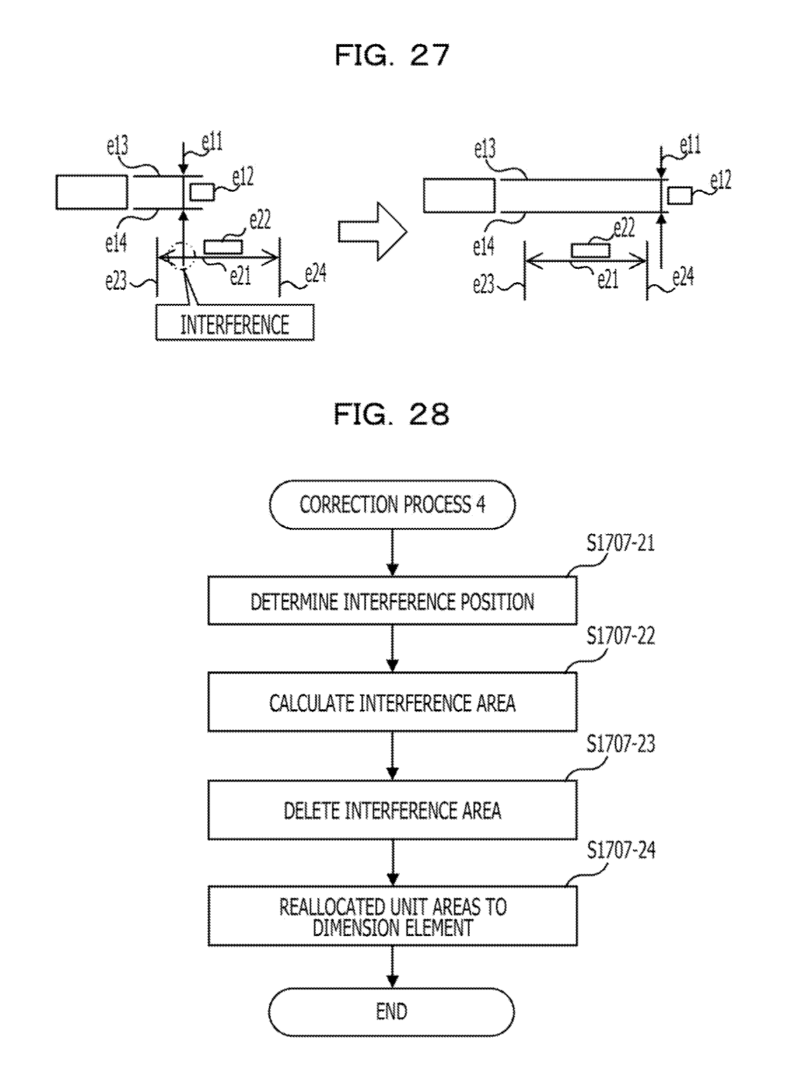

FIG. 27 illustrates an example of how to correct the interference between dimension lines. In the left figure in FIG. 27, a dimension line e11 interferes with a dimension line e21 in a set of the dimension line e11, a dimension value e12, an extension line e13, and an extension line e14 and a set of the dimension line e21, a dimension value e22, an extension line e23, and an extension line e24. In this case, as illustrated in the right figure in FIG. 27, the dimension line e11 and the dimension value e12 are moved rightward and the extension lines e13 and e14 are extended to substantially eliminate the interference.

Although the extension lines are not illustrated in FIGS. 25 and 26 for convenience, the extension lines may be extended, if necessary, also in the cases in FIGS. 25 and 26.

Correction process 4 will now be described in detail. FIG. 28 illustrates Correction process 4 in detail. Correction process 4 is performed when a dimension value or a dimension line interferes with an extension line (refer to FIG. 18). Accordingly, one of the two interfering dimension elements is an extension line in the description with reference to FIG. 28.

Referring to FIG. 28, in Step S1707-21, the arrangement position corrector 15 determines all the duplicated unit areas from the unit areas allocated to the two dimension elements for which the interference is detected. In Step 51707-22, the arrangement position corrector 15 calculates the range of the part where the interference occurs (interference area) on the basis of all the duplicated unit areas. For example, a range formed by the perimeter of all the duplicated unit areas may be set as the interference area or a more specific range may be calculated as the interference area. The more specific range indicates a range resulting from calculation of an interference position or an interference range on the basis of the attribute information about the interfering dimension elements in the unit of the coordinate values of the drawing area and addition of a certain margin to the calculated interference position or range.

In Step S1707-23, the arrangement position corrector 15 deletes the part concerning the interference area in the interfering extension line.

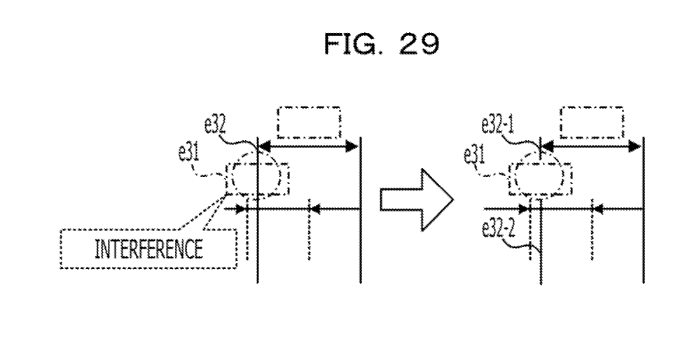

FIG. 29 illustrates an example of how to correct the interference between a dimension value and an extension line. In the left figure in FIG. 29, a dimension value e31 interferes with an extension line e32. In this case, as illustrated in the right figure in FIG. 29, the part concerning the interference area in the extension line e32 is deleted.

The extension line may be deleted on the display or the extension line may be divided in the deletion of the extension line. In the former case, the attribute information indicating a non-display range may be provided for the extension line and the range in which the extension line is overlapped with the interference area may be recorded as the non-display range of the extension line. In the latter case, the original extension line may be shortened and a new extension line may be generated. Specifically, in the example in FIG. 29, the original extension line e32 may be shortened into the shape of an extension line e32-1 and data (attribute information) about a new extension line e32-2 may be added to the current view. The shortening of the original extension line is realized by correcting the arrangement reference position and the arrangement range of the extension line.

Referring back to FIG. 28, in Step S1707-24, the arrangement position corrector 15 reallocates the unit areas to the modified extension line. When a new extension line is generated, the arrangement position corrector 15 allocates the unit areas to the new extension line.

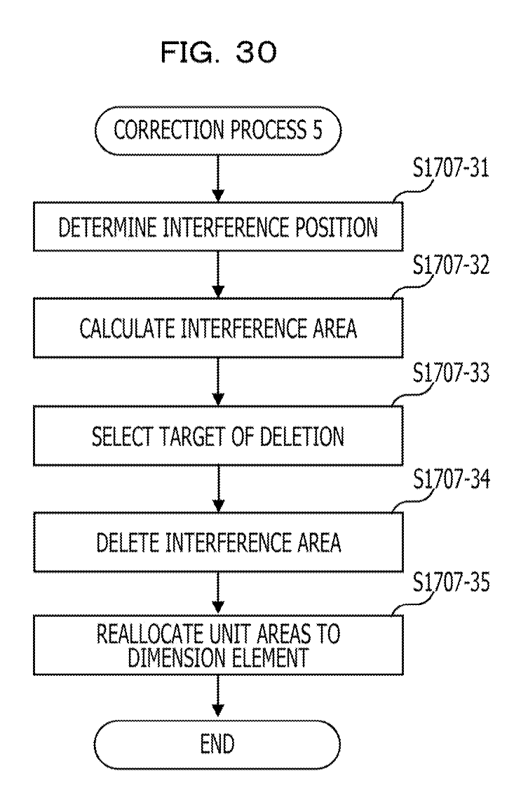

Correction process 5 will now be described in detail. FIG. 30 illustrates Correction process 5 in detail. Correction process 5 is performed when the interference occurs between extension lines (refer to FIG. 18).

Referring to FIG. 30, Steps S1707-31 and S1707-32 are performed in the same manner as in Step S1707-21 and S1707-22 in FIG. 28. In Step S1707-33, the arrangement position corrector 15 selects an extension line from which the part concerning the interference area is to be deleted from the two interfering extension lines. The selection of the target of the deletion may be based on, for example, the length and/or direction of the extension line. Specifically, the arrangement position corrector 15 compares the lengths (arrangement ranges) of the two interfering extension lines with each other to keep the shorter extension line and to select the longer extension line as the target of the deletion. If the two extension lines have substantially the same length, the arrangement position corrector 15 selects the target of the deletion in order of priority: the highest priority is given to a diagonal direction, the next highest priority is given to a horizontal direction, and the lowest priority is given to a vertical direction. However, the extension line to be set as the target of the deletion may be arbitrarily set or interactively selected.

In Step S1707-34, the arrangement position corrector 15 deletes the part concerning the interference area from the extension line selected as the target of the deletion.

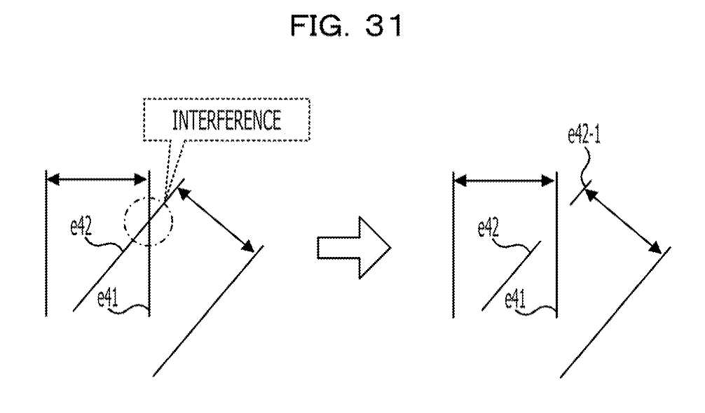

FIG. 31 illustrates an example of how to correct the interference between extension lines. In the left figure in FIG. 31, an extension line e41 interferes with an extension line e42. It is assumed here that the two extension lines have substantially the same length. Accordingly, in this case, as illustrated in the right figure in FIG. 31, the part concerning the interference area is deleted from the diagonal extension line e42.

The deletion of the interference area from the extension line is performed in a manner similar to the one described with reference to FIG. 28.

Referring back to FIG. 30, in Step S1707-35, the arrangement position corrector 15 reallocates the unit areas to the modified extension line. When a new extension line is generated, the arrangement position corrector 15 allocates the unit areas to the new extension line.

Correction process 6 will now be described in detail. Correction process 6 is performed when a note interferes with a drawing frame area, a view (a view other than the view to which the note belongs), a dimension element, or another note (refer to FIG. 18).

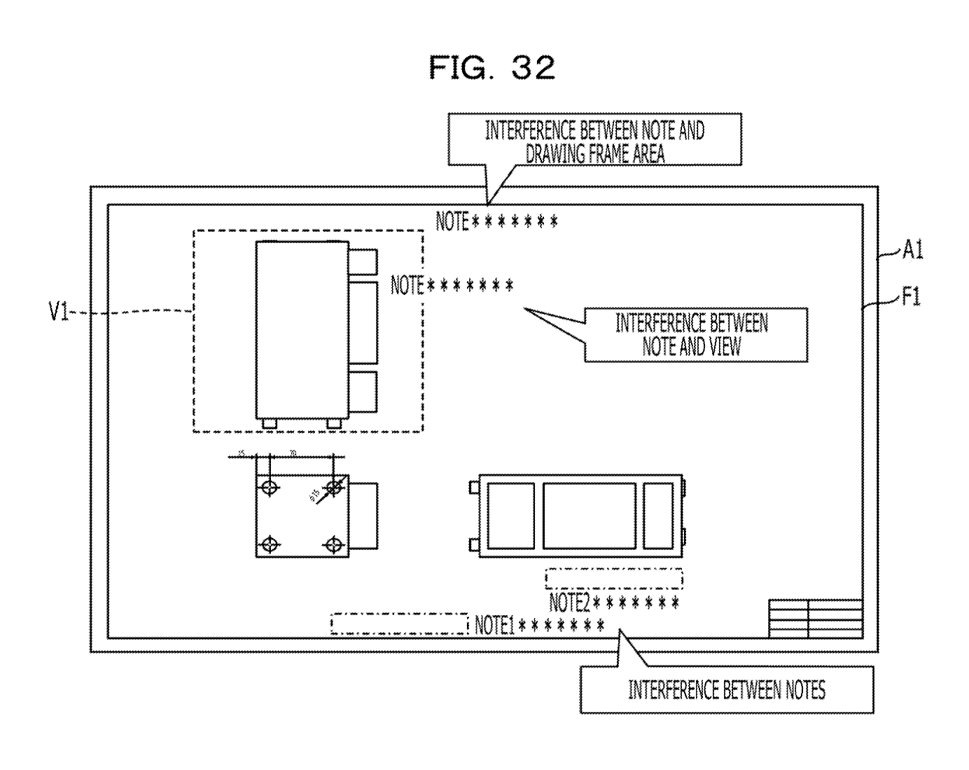

FIG. 32 illustrates examples of the interference concerning notes. The interference between a note and the drawing frame area, the interference between a note and the view V1, and the interference between notes are exemplified in FIG. 32.

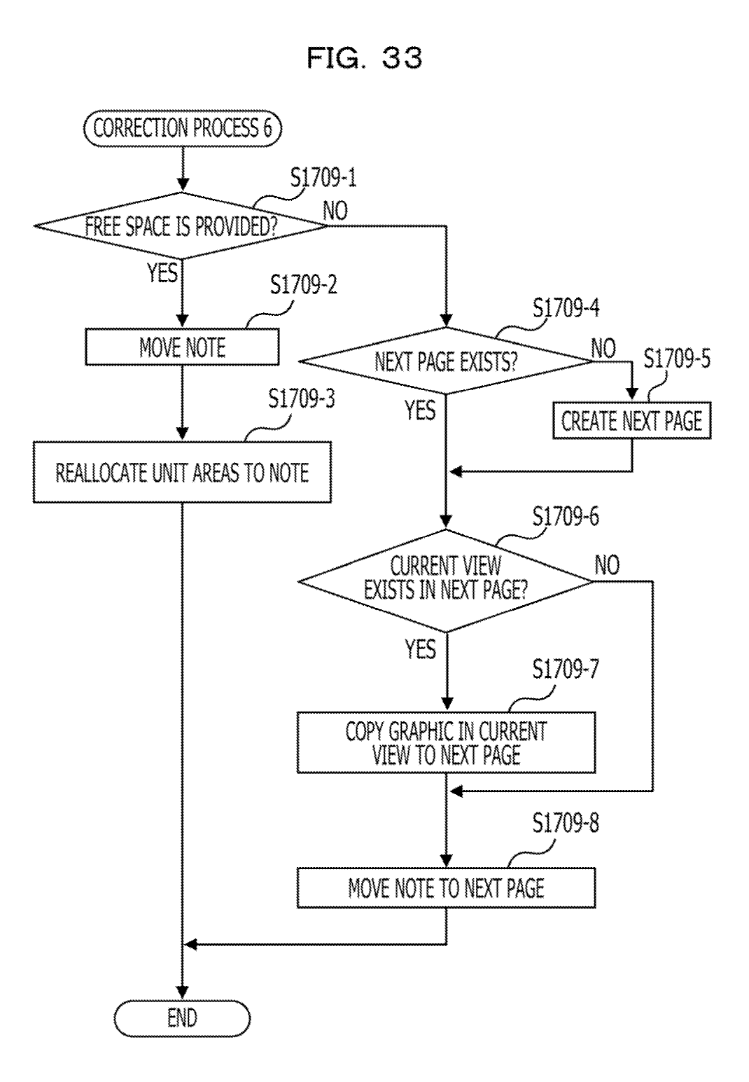

FIG. 33 illustrates Correction process 6 in detail. At least one of the two interfering drawing elements is a note in the description with reference to FIG. 33.

Referring to FIG. 33, in Step S1709-1, the arrangement position corrector 15 determines whether a free space sufficient to accommodate a note (target note) interfering with another drawing element is provided around the target note. A setting value may be recorded in the auxiliary storage unit 102 in advance as the range surrounding the target note. Accordingly, it is determined in Step S1709-1 whether, for example, a free space is provided in a range defined by a rectangular area, a circular area, or another graphic having a certain size around the center of the area of the note. The determination of the presence of the free space may be based on the arrangement range of the target note. In other words, it may be determined whether a free space that may contain the arrangement range is provided.

If a free space is found (Yes in Step S1709-1), then in Step S1709-2, the arrangement position corrector 15 moves the target note to the free space. If the interference occurs between notes, the arrangement position corrector 15 determines whether a free space is provided in each of the notes and moves the note including a free space. If both of the notes include a free space, the arrangement position corrector 15 moves a note having a smaller amount of movement. In Step S1709-3, the arrangement position corrector 15 reallocates unit areas to the note that is moved.

If no free space is found (No in Step S1709-1), then in Step S1709-4, the arrangement position corrector 15 determines whether the page next to the current page exists on the basis of the drawing data. If the next page does not exist (No in Step S1709-4), then in Step S1709-5, the arrangement position corrector 15 adds the next page to the drawing data. In Step S1709-6, the arrangement position corrector 15 determines whether the current view exists in the next page on the basis of the drawing data. If the current view does not exist in the next page (No in Step S1709-6), the process goes to Step S1709-8. If the current view exists in the next page (Yes in Step S1709-6), then in Step S1709-7, the arrangement position corrector 15 copies the current view and the graphic in the current view into the next page. In Step S1709-8, the arrangement position corrector 15 moves the note to the next page. The arrangement position corrector 15 arranges the target note at a position that is not overlapped with the drawing frame area or another view in the next page.

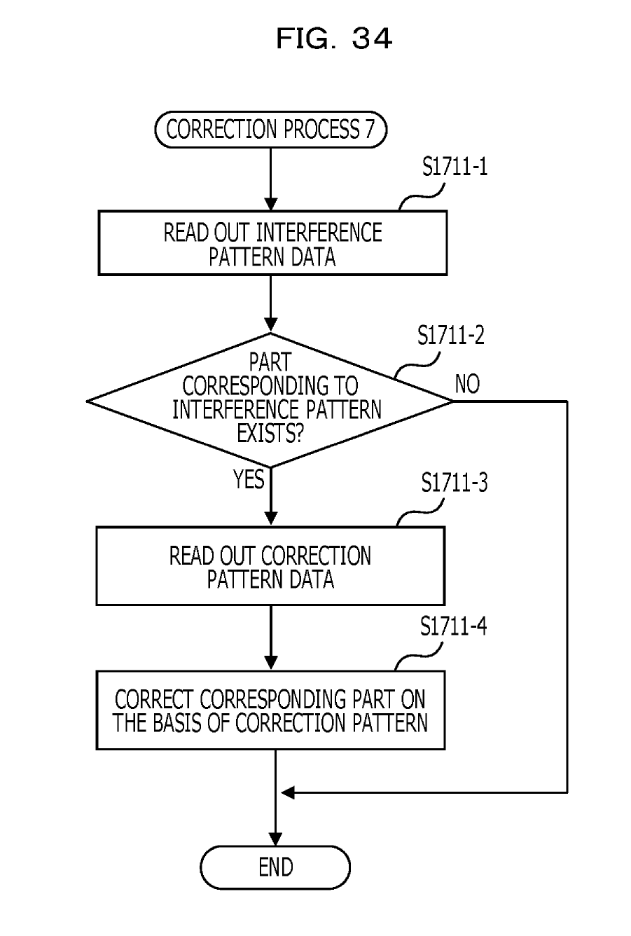

Correction process 7 will now be described in detail. FIG. 34 illustrates Correction process 7 in detail.

Referring to FIG. 34, in Step S1711-1, the arrangement position corrector 15 reads out the interference pattern data. In Step S1711-2, the arrangement position corrector 15 determines whether the part corresponding to the interference pattern defined in the interference pattern data exists on the basis of the attribute information about each drawing element. If the part corresponding to the interference pattern exists (Yes in Step S1711-2), then in Step S1711-3, the arrangement position corrector 15 reads out the correction pattern data. In Step S1711-4, the arrangement position corrector 15 corrects the corresponding part on the basis of the correction pattern corresponding to the interference pattern. If the part corresponding to the interference pattern does not exist (No in Step S1711-2), the process in FIG. 34 is terminated.

The correction by using the correction library is performed, for example, in a case in which, when an arrow part of a dimension line interferes with a dimension value belonging to the same set as that of the dimension line, the arrow is changed to a black point or the direction of the arrow is changed.

In manual correction of an interfering part, the interference pattern may be automatically added to the interference pattern data and the content of correction may be automatically added to the correction pattern data.

As described above, with the drawing correction assisting apparatus 10 according to the present embodiment, the drawing area is divided into the unit areas, the unit areas are allocated to each drawing element, and it is automatically determined whether the interference occurs between the drawing elements on the basis of the presence of the duplication of the unit areas. Accordingly, it is possible to reduce the count of failure to detect the interference part.

In addition, since simple logic in which the presence of the duplication of the unit areas is checked is adopted, it is possible to reduce the time required to determine whether the interference occurs.

Furthermore, the appropriate correction process is automatically performed to the interference that is detected depending on the types of the drawing elements concerning the interference. As a result, the interference may be efficiently and substantially eliminated.

Instead of the automatic correction, only the result of checking of the interference may be output. It is possible to prevent correction failure also by the output of the result of checking of the interference. In addition, the working efficiency is improved, compared with a case in which the interfering part is visually detected. The result of checking of the interference may be output, for example, in a manner in which the drawing data is displayed and the interfering part is highlighted.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiments of the present inventions has been described in detail, it should be understood that various changes, substitutions, and alterations could be made hereto without departing from the spirit and scope of the invention.

What is claimed is:

1. A computer-readable storage medium storing a drawing correction assisting program causing a computer to execute a process comprising:
dividing a drawing area of two-dimensional drawing data into unit areas and storing positional information for every unit area in a storage unit;
allocating at least one of the unit areas to each of a plurality of drawing elements included in the drawing area on the basis of arrangement information about each drawing element and the positional information for every unit area and storing association information associating each drawing element with the allocated at least one unit area in the storage unit; and
determining whether interference occurs between the plurality of drawing elements on the basis of the presence of duplication of the allocated unit areas in the stored association information.

2. The storage medium according to claim 1 storing the drawing correction assisting program causing the computer to execute the process, with the process further comprising:
substantially eliminating the interference by a process corresponding to types of the drawing elements involving in the interference when the determining determines that the interference occurs between the involved drawing elements.

3. The storage medium according to claim 2, wherein the substantially eliminating includes:
moving one of the drawing elements involving in the interference to a free space in the drawing area that is sufficient to accommodate the drawing element.

4. The storage medium according to claim 3,
wherein, when the drawing element involving in the interference is a dimension value or a dimension line, the substantially eliminating further includes:
determining a movement direction of the dimension value or the dimension line on the basis of positional relationship between an arrangement direction of the dimension value or the dimension line and a reference point.

5. The storage medium according to claim 4, wherein the reference point is an extension point of an extension line that is one of the plurality of drawing elements in the drawing area.

6. The storage medium according to claim 3,
wherein, when the interference occurs between extension line, the substantially eliminating deletes a part concerning the interference from one of the extension line.

7. A drawing correction assisting apparatus comprising:
a drawing-area dividing divider configured to divide a drawing area of two-dimensional drawing data into unit areas and storing positional information for every unit area in a storage unit;
a unit-area allocator configured to allocate at least one of the unit areas to each of a plurality of drawing elements included in the drawing area on the basis of arrangement information about each drawing element and the positional information for every unit area and storing association information associating each drawing element with the allocated at least one unit area in the storage unit; and
an interference determiner configured to determine whether interference occurs between the plurality of drawing elements on the basis of the presence of duplication of the allocated unit areas in the stored association information.

8. The drawing correction assisting apparatus according to claim 7 further comprising:
a position corrector configured to substantially eliminate the interference by a process corresponding to the types of the drawing elements involving in the interference when the interference determiner determines that the interference occurs between the drawing elements.

9. The drawing correction assisting apparatus according to claim 8,
wherein the position corrector is further configured to move one of the drawing elements involving in the interference to a free space sufficient to accommodate the drawing element in the drawing area.

10. The drawing correction assisting apparatus according to claim 9,
wherein, when the drawing element involving in the interference is a dimension value or a dimension line, the position corrector substantially eliminate the interference by determining a movement direction of the dimension value or the dimension line on the basis of positional relationship between an arrangement direction of the dimension value or the dimension line and a reference point.

11. The drawing correction assisting apparatus according to claim 10, wherein the reference point is an extension point of an extension line that is one of the plurality of drawing elements in the drawing area.

12. The drawing correction assisting apparatus according to claim 10,
wherein, when the interference occurs between extension line, the position corrector deletes a part concerning the interference from one of the extension line.

13. A drawing correction assisting method executed by a computer, the method comprising:
dividing a drawing area of two-dimensional drawing data into unit areas and storing positional information for every unit area in a storage unit;
allocating at least one of the unit areas to each of the plurality of drawing elements included in the drawing area on the basis of arrangement information about each the drawing element and the positional information for every unit area and storing association information associating each drawing element with the allocated at least one unit area in the storage unit; and
determining whether interference occurs between the plurality of drawing elements on the basis of the presence of duplication of the allocated unit areas in the stored association information.

14. The drawing correction assisting method according to claim 13, further comprising:
substantially eliminating the interference by a process corresponding to the types of the drawing elements involving in the interference when the determining step determines that the interference occurs between the drawing elements.

15. The drawing correction assisting method according to claim 14,
wherein the substantially eliminating includes moving one of the drawing elements involving in the interference to a free space in the drawing area that is sufficient to accommodate the drawing element in the drawing area.

16. The drawing correction assisting method according to claim 15,
wherein, when the drawing element concerning the interference is a dimension value or a dimension line, the substantially eliminating further includes determining a movement direction of the dimension value or the dimension line on the basis of positional relationship between an arrangement direction of the dimension value or the dimension line and a reference point.

17. The drawing correction assisting method according to claim 15,
wherein, when the interference occurs between extension line, the substantially eliminating includes deleting a part concerning the interference from one of the extension line.

18. The drawing correction assisting method according to claim 13, further comprising:
allocating at least one of the unit areas to a drawing frame area and a title, the drawing frame area includes the plurality of drawing elements, and the title identifies the two-dimensional drawing data in the drawing area.

19. The drawing correction assisting method according to claim 13, further comprising:
allocating at least one of the unit areas to each of a plurality of views of a drawing object included in the two-dimensional drawing data.

20. The drawing correction assisting method according to claim 19, wherein allocating at least one of the unit areas to each of the plurality of drawing elements includes:
allocating at least one of the unit areas to each of the plurality of drawing elements in each of the plurality of views.
